(19) United States
(12) Patent Application Publication
(10) Pub. No.: US 2009/0063298 A1
(43) Pub. Date: Mar. 5, 2009

(54) ONLINE INFORMATION MARKETPLACE FOR OBTAINING A QUALIFIED BUSINESS OPPORTUNITY

(76) Inventors: Daniel J. Hodges, Santa Clara, CA (US); Yusaku Sako, San Mateo, CA (US); Pramod Thangali, Saratoga, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 12/200,777

(22) Filed: Aug. 28, 2008

Related U.S. Application Data
(63) Continuation-in-part of application No. 11/490,788, filed on Jul. 21, 2006.

(51) Int. Cl. G06Q 30/00

(52) U.S. Cl. 705/26

(57) ABSTRACT

A computer-implemented method for obtaining information is described. The computer-implemented method includes receiving an information request for a qualified business opportunity from a user. The computer-implemented method also includes providing the information request to an information source. Moreover, the computer-implemented method includes receiving the qualified business opportunity from the information source. The computer-implemented method further includes sending the qualified business opportunity to the user. Furthermore, the computer-implemented-method includes awarding compensation to the information source.

### CROSS-REFERENCE TO RELATED APPLICATIONS

This is a continuation-in-part of U.S. patent application Ser. No. 11/490,788, filed on Jul. 21, 2006, which is hereby incorporated by reference in its entirety.

### TECHNICAL FIELD

The disclosed embodiments relate generally to online services, and more particularly, to an online marketplace for buying and selling information.

### BACKGROUND

Contact information is important to today's businesses. Contact information may be used for various business initiatives, such as marketing to potential customers, recruiting personnel, or sourcing new business opportunities, clients, or suppliers. Contact information may be used with various marketing techniques, such as targeted marketing and telemarketing, in order to further these business initiatives. As a result, businesses often expend many resources to acquire contact information.

Currently, contact information may come in the form of contact lists purchased from firms that compile such lists. However, these contacts lists have some shortcomings. One is that they may be incomplete; contact lists often do not include persons of influence or decisions-making authority that are not in senior management. Also, contact lists can be quite expensive. Furthermore, contact lists often do not leverage the redundant information available throughout the world as a way to verify the information in the lists. These shortcomings have made contact lists less effective.

Accordingly, there is a need for more effective ways to acquire contact information.

### SUMMARY

A computer-implemented method for obtaining information is described. The computer-implemented method includes receiving an information request for a qualified business opportunity from a user. The computer-implemented method also includes providing the information request to an information source. Moreover, the computer-implemented method includes receiving the qualified business opportunity from the information source. The computer-implemented method further includes sending the qualified business opportunity to the user. Furthermore, the computer-implemented method includes awarding compensation to the information source.

Other features and advantages of embodiments of the present invention will be apparent from the accompanying drawings and from the detailed description that follows.

### BRIEF DESCRIPTION OF THE DRAWINGS

For a better understanding of the aforementioned embodiments, as well as additional embodiments thereof, reference should be made to the Description of Embodiments below, in conjunction with the following drawings in which like reference numerals refer to corresponding parts throughout the figures

FIG. 1 is a conceptual diagram illustrating transactions between information sources and users via an online information marketplace in accordance with some embodiments.

FIG. 2 is a block diagram illustrating a computer network in accordance with some embodiments of an online information marketplace.

FIG. 3 illustrates an embodiment of a remote interface in accordance with some embodiments of an online information marketplace.

FIG. 4 illustrates an embodiment of a web page for downloading a remote interface in accordance with some embodiments of an online information marketplace.

FIG. 5 is a flow diagram illustrating a process of buying and: selling information in accordance with some embodiments of an online information marketplace.

FIGS. 6A-6C are flow diagrams illustrating an exemplary user flow in a session in an online information marketplace in accordance with some embodiments.

FIG. 7 illustrates an embodiment of a structured form for recruitment information in accordance with some embodiments of an online information marketplace.

FIG. 8 illustrates an embodiment of a structured form for business development and sales related information in accordance with some embodiments of an online information marketplace.

FIG. 9 illustrates an embodiment of a structured form for marketing leads in accordance with some embodiments of an online information marketplace.

FIG. 10 is a flow diagram illustrating a process, for entering information to an online information marketplace in accordance with some embodiments of an online information marketplace.

FIG. 11 illustrates an ask page according to an embodiment of an online information marketplace in accordance with some embodiments of an online information marketplace.

FIG. 12 illustrates a Backus-Naur form to generate a natural language format from a recruitment structured form in accordance with some embodiments of an online information marketplace.

FIG. 13 is a flow diagram illustrating a process for generating an information signature in accordance with some embodiments of an online information marketplace.

FIG. 14 is a flow diagram illustrating a process for generating an information request signature in accordance with some embodiments of an online information marketplace.

FIG. 15 is a flow diagram illustrating a process for using matching heuristics in accordance with some embodiments of an online information marketplace.

FIG. 16 is a flow diagram illustrating a process of providing information to an online information marketplace in accordance with some embodiments.

FIG. 17 illustrates an exemplary interface for editing templates in accordance with some embodiments.

FIG. 18 illustrates an exemplary interface for providing information to an online information marketplace in accordance with some embodiments.

FIG. 19 illustrates an exemplary interface for adding a custom information field in accordance with some embodiments.

FIG. 20 is a flow diagram illustrating a process for submitting information including information verification in accordance with some embodiments of an online information marketplace.

FIG. 21 illustrates a form for submitting recruitment information in accordance with some embodiments of an online information marketplace.

FIG. 22 illustrates a form for submitting sales and business development information in accordance with some embodiments of an online information marketplace.

FIG. 23 illustrates a form for submitting marketing information in accordance with some embodiments of an online information marketplace.

FIG. 24 is a flow diagram illustrating a process for a buyer to verify the quality of information purchased in accordance with some embodiments of an online information marketplace.

FIG. 25 illustrates a web page for an information buyer to provide quality feedback on information purchased in accordance with some embodiments of an online information marketplace.

FIG. 26 is a flow diagram illustrating a process flow between a user and an online information marketplace to obtain a qualified business opportunity from an information source in accordance with some embodiments of an online information marketplace.

FIG. 27 illustrates a form for submitting an information request for a qualified business opportunity in accordance with some embodiments of an online, information marketplace.

FIG. 28 is a flow diagram illustrating a process for rejecting a qualified business opportunity in accordance with some embodiments of an online information marketplace.

FIG. 29 illustrates a web portal for an information source in accordance with some embodiments of an online information marketplace.

FIG. 30 illustrates a web portal for buyers in accordance with some embodiments of an online information marketplace.

FIG. 31 illustrates a table listing exemplary amounts of compensation to one or more information providers in accordance with some embodiments.

FIG. 32 illustrates a data structure in accordance with some embodiments.

FIG. 33 is a block diagram illustrating an information system in accordance with some embodiments.

FIG. 34 is a block diagram illustrating a client in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures; components, etc. have not been described in detail so as not to unnecessarily obscure aspects of the embodiments.

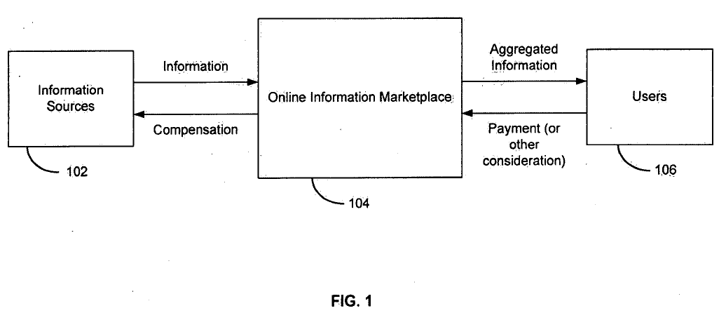

Attention is directed to FIG. 1, which illustrates transactions between information sources 102 and users 106 via an online information marketplace 104 in accordance with some embodiments. As used herein, a “user” 106 refers to anyone who has access to the online information marketplace 104. For some embodiments, a user 106 is registered with the online information marketplace and has an account with the online information marketplace 104. In some of these embodiments, ah “information source” refers to a user 106 who has provided and/or is providing information to the online information marketplace 104 so that the information may be purchased by users 106. Thus, in these embodiments, all information sources 102 are also users 106, and a user 106 can become an information source 102 by providing information to the online information marketplace 104.

One or more information sources 102 provide information to an online information marketplace 104. The online information marketplace 104 collects the information from the information sources 102. The online information marketplace 104 may also collect, information using automated processes, such as crawling web sites or databases for information, in addition to receiving information from information sources 102. For some embodiments, the online information marketplace 104 also aggregates and analyzes the collected information. The online information marketplace 104 may provide at least a portion of the information collected by the online information marketplace to one or more users 106 in exchange for payment or other consideration from the users 106; the one or more users 106 purchase information from the online information marketplace 104. Whenever a user 106 has purchased information from the online information marketplace 104, compensation is awarded to the information sources 102 that provided the particular information purchased by the user 106. The amount of compensation awarded to an information source 102 may be based on the total number of information sources 102 who provided the purchased information. The amount of compensation may be further based on which information source 102 was the first to provide the purchased information, or even the order in which the information sources 102 provided the purchased information.

In other words, the online information marketplace 104 provides a platform where users 106 can buy and sell information. Information sources 102 may provide information for sale to the online information marketplace 104, where the provided information may be sold to users 106. The provided information and information obtained from crawling web sites may be purchased by other users 106, and the information sources 102 or sources that provided the purchased information are awarded compensation. For some embodiments, an information source 102 may provide information to the online information marketplace 104 anonymously with respect to other users 106; the online information marketplace 104 does not reveal to other users 106 the person(s) who provided a particular item of information. Also, for some embodiments, a user 106 may search for or purchase information anonymously with respect to information sources 102; the online information marketplace 104 docs not reveal to an information source 102 the searcher or purchaser of an item of information.

For some embodiments, information that may be exchanged via the online information marketplace 104 includes Contact information. Contact information may include information associated with one or more persons, such as first and last name, address, geographical region, phone number (which may include numbers for fax; mobile phone, or pager), email address, occupation, job title, job function company name, industry, and so forth. Contact information may further include supervisors, subordinates, web page, interests (business or personal), memberships, education, personal preferences, prior employment, and so forth. It should be appreciated, however, that the information that may be included in contact information, described above, are merely exemplary. Contact information may include other information in addition to the information categories listed above.

For case of understanding, the information described in the embodiments disclosed below is contact information. However, it should be appreciated that the disclosed embodiments may be adapted for other types of information.

It should be appreciated that while the description above describes the users 106 as buying information in exchange for (monetary or credit) payment, other forms of consideration may be used. For example, for some embodiments, users 106 may acquire information in exchange for viewing one or more advertisements. In some other embodiments, a user 106 may acquire information if he provides new information to the online information marketplace 104; the user 106 trades information for information.

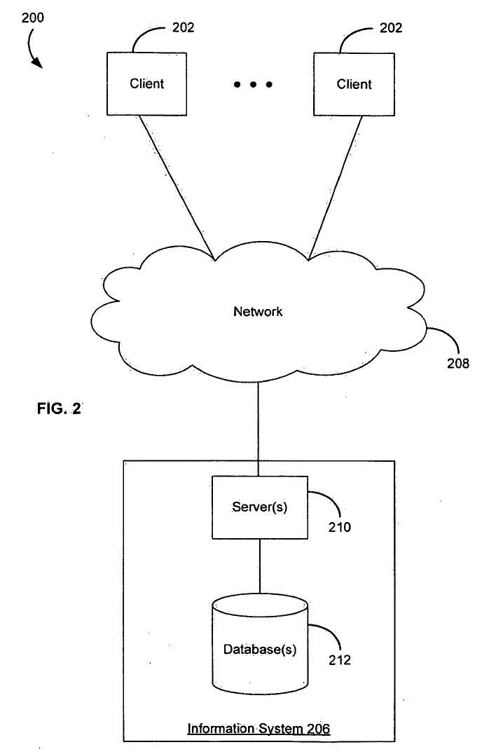

Attention is now directed to FIG. 2, which is a block diagram illustrating a computer network in accordance with some embodiments. The computer network 200 includes one or more clients 202, an information system 206, and a network 208 that interconnects these components. The network 208 may include any of a variety of communication networks, such as local-area networks (LAN), wide-area networks (WAN), wireless networks, and the Internet.

The clients 202 are devices from which a user 106 may access the information system 206 to buy and/or to provide contact information. The client 202 may be any device capable of communicating with other computers, devices, and so forth, including the information system 206, through the network 208. Examples of client devices may include, without limitation, desktop computers, notebook (or laptop) computers, personal digital assistants (PDAs), mobile phones, network terminals, electronic, books, and so forth. For some embodiments, the client device 202 includes one; or more applications for communicating with other computers or devices through the network 208. One example, of an application is a web browser. In some embodiments, the client device 202 includes one or more applications specifically designed for communicating with information system 206.

The information system 206 of an online information marketplace 104 provides a platform where users 106 may buy or sell contact information. The information system 206 may include one or more servers 210 and one or more databases 212. The server(s) 210 provides a front end interface with which users 106 interact to access the information system 206. For some embodiments, the servers) 210 provides a Web-based interface comprising pages, written in the Hypertext Markup Language (HTML)/Extensible HTML (XML), Dynamic HTML, Wireless Markup Language (WML), Wireless Application Protocol (WAP), i-mode, Java, Asynchronous JavaScript and XML (AJAX), or the like and based on other protocols and languages suitable for authoring web pages. The web-based interface may be accessed via a web browser or other specialized application. The contact information provided by users 106, as well as other information, may be stored in a database(s) 212. The database(s) 212 may be implemented using any of a plurality of database models that are currently known or later developed, such as a relational model or an object database model.

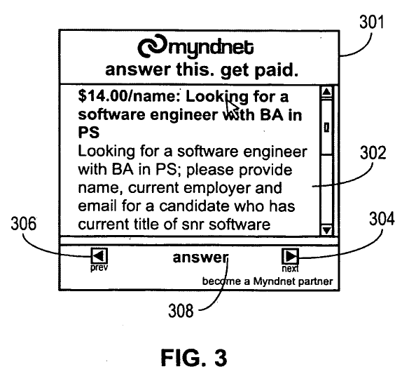

For some embodiments, an online information marketplace 104 includes a remote interface. FIG. 3 illustrates an embodiment of a remote interface 301. A remote interface may include an information request window 302 for a user 106 to view information requests. For some embodiments, a user 106 scrolls through information requests using a next key 304 or a previous key 306. For an alternative embodiment, a user 106 accesses all information requests by scrolling through a list in an information window 302.

To respond to an information request, a user 106 would select an answer key 308. For some embodiments, this action would direct the user 106 to a web-based interface provided by servers) 210, where a user 106 could enter in the information responsive to an information request. For other embodiments, a user 106 may respond to an information request by selecting an information request. For example, a user 106 may select an information request using a mouse to click on an information request, a link corresponding to an information request, or an icon corresponding to an information request.

A remote interface 301; for some embodiments, is provided by a server or system other than an information system 206. For some embodiments, remote interface 301 receives information requests transmitted from an information system 206. Information requests include requests for information, such as contact information, that a user 106 is interested in buying from an information source 102. The remote interface 301 may be dedicated to display a specific category of information requests that an information system 206 communicates to the remote interface 301. For such an embodiment, information system 206 filters the information; requests submitted to categorize each information request. For some embodiments, categories of information requests include sales, business development, recruitment, marketing, qualified business opportunities, and other business areas. Therefore, an online information marketplace 104 may communicate one category or type of information requests to a remote interface 301. For other embodiments, a remote interface 301 is configured to receive all or a subset of categories of information requests from an information system 206.

For some: embodiments, a user 106 downloads a remote interface 301 from an online information marketplace 104 to include as part of a web-based interface, such as a web page. For example, a user 106 may embed or integrate an application or program that operates as a remote interface 301 into a web page provided by the user 106 on a server not associated with the online information marketplace 104. Other embodiments include downloading code to include as part of a web-based interface, such as a web page, to receive information from an information system 206.

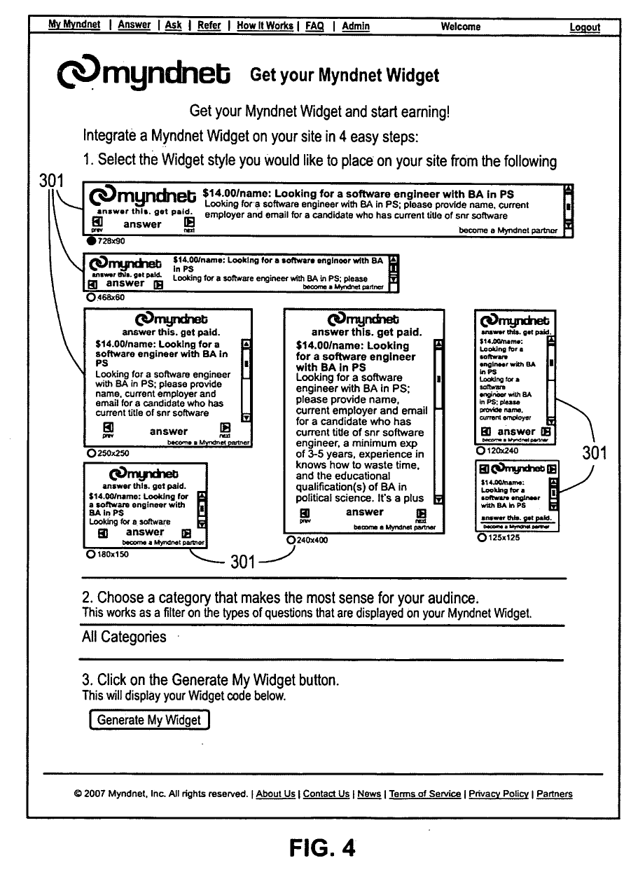

FIG. 4 illustrates an embodiment of a web page of an online information marketplace 104 that a user 106 accesses to select a remote interface 301 to download. As illustrated in FIG. 4, a user 106 selects from different sizes to receive code that a user 106 can include, or incorporate into a web page. Downloaded code may be any type that provides an interface that a user 106 may interact with to receive or respond to information requests originating from an information system 206, such as client-side scripting including JavaScript, presentation definition language including Cascading Style Sheets (CSS), Adobe Flash applications, and markup languages including Hypertext Markup Language (HTML), Extensible HTML (XML), and Dynamic HTML.

For some embodiments, a remote interface 301 communicates with an information system 206 through a communication network 208, such as a local-area network (LAN), a wide-area network (WAN), a wireless network, and/or the Internet. A remote interface 301, for some embodiments, communicates with information system 206 through a Really Simple Syndication (RSS) feed. For other embodiments, an information system 206 communicates with a remote interface 301 using protocols including a unicast protocol, such as User Datagram Protocol (UDP), a Real-time Streaming Protocol (RTSP), a Real-time Transport Protocol (RTP), a Real-time Transport Control Protocol (RTCP), a multicast protocol, such as IP Multicast, a peer to peer (P2P) protocol, and Transmission Control Protocol (TCP).

For some embodiments, a remote interface 301 includes an identifier. An identifier may be any alphanumerical combination including a Uniform Resource Locator (URL), an Internet protocol address, or any other method for identifying a specific remote interface 301. The identifier may be used by an information system 206 to determine which remote interface 301 a user 106 uses to submit a response to an information request. For example, the identifier included or embedded in a remote interface is communicated to an online information marketplace 104 when a user selects an information request for submitting a response. For some embodiments, the identifier may be used to provide a referral commission to the owner or operator of a web-based interface that provides the remote interface 301 that resulted in information being submitted to an online information marketplace 104.

Similarly, an e-mail containing an information request may include an identifier. This identifier may be communicated to an online information marketplace 104 when a user replies to the e-mail to submit information responsive to the information request. An online information marketplace 104 may use this identifier to determine who referred an information source 102. Alternatively, an e-mail could include, a link that when selected indicates the source of an information request. For some embodiments, this information can be used to pay a referral fee to other users 106 who forward information requests.

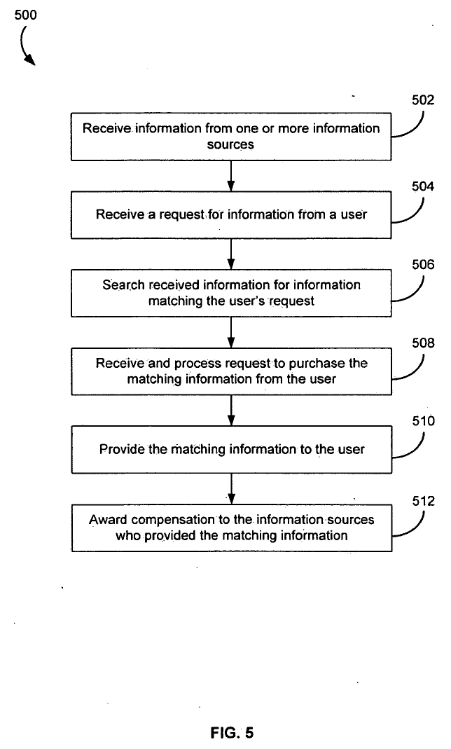

Attention is now directed to FIG. 5, which is a flow diagram illustrating a process flow 500 of buying and selling information in an online information marketplace 104 in accordance with some embodiments. Contact information is received from one or more, information sources 102 (502). The received contact information may include contact information associated with one or more persons (“contacts”). The received contact information may include redundant information, i.e. information that repeats information that has been provided before and already stored in the online information marketplace 104.

The received contact information may be stored in the online information marketplace 104. For some embodiments, the contact information stored in the database 212 is also aggregated and analyzed to resolve redundancies and inconsistencies, to identify, connections or relationships between contacts, and/or to verify the contact information. This may include consolidating redundant information and resolving inconsistencies in accordance with one or more predefined rules.

For some embodiments, the contact information is received in the form of one or more attribute-value pairs. An attribute (or a field) is identified by a field name and has a corresponding data type. Examples of data types include text (length-limited or not), number (e.g., integer, float), number range, name, address, date, date range, multiple choice, and so forth. For some embodiments, a predefined set of one or more default fields are provided by the online information marketplace 104.

The online information marketplace 104 may also allow the creation of custom, user-defined fields, further details of which are described below. A user 106 may define a user-defined field by providing a field name and a data type for the attribute. Once a user-defined field is created, it is saved in the information system 206 and may be adopted by other users 106.

A request for contact information is received from a user 106 (504). Whenever a user 106 wishes to acquire contact information, the user 106 may make a request to the online information marketplace 104. For some embodiments, the request is a search query for contact information in the database 212 that satisfies one or more parameters specified in the query. The information stored in the database 212 is searched for contacts that satisfy the query (506). The result of the search, or a summary or preview thereof, is presented to the user 106. For some embodiments, the results are presented as a number of unique contacts that satisfy the parameters in the query.

The user 106 may purchase the contact information found in the search. The user 106 places a request to purchase the information. The purchase request, which may include a method of payment, is received and processed (508). After the request is processed, the purchased contact information is presented to the user 106 (510). For some embodiments, the contact information is not presented to the user 106 until the payment has been made; electronically or otherwise. The contact information shown to the user 106 may include names, phone numbers, physical addresses, and email addresses. For some embodiments, the user 106 may choose which of the above are shown (names, phone numbers, etc.).

For some embodiments, the value or the purchase price of the contact information to be paid by the user 106 may vary based on the focus of the search query that yielded the contact information to be purchased. For example, if a first search searched for CEO's and a second search searched for CEO's who play golf, the per item or per unit purchase price of the information from the second search is higher because the second search is more focused. In other words, search results from more focused or narrow searches are more valuable.

The information sources 102 that provided the purchased information are awarded compensation (512). For some embodiments, the compensation may include money paid to the information sources 102 via electronic payment or transfer. In some other embodiments, compensation may include credits that may be applied toward purchases of contact or other information from the information system, or other non-monetary compensation. For some embodiments, the amount of compensation that is awarded for a particular item of contact information (e.g., an attribute-value pair associated with a contact) may be based on the number of information sources 102 who provided the particular item, the completeness or accuracy of the provided item of information, which information source 102 provided the particular item first, and/or the order in which the information sources 102 provided the information.

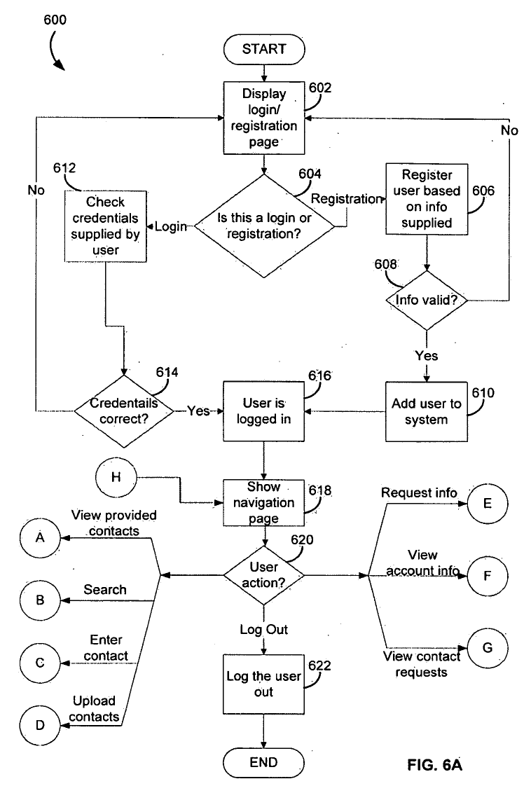

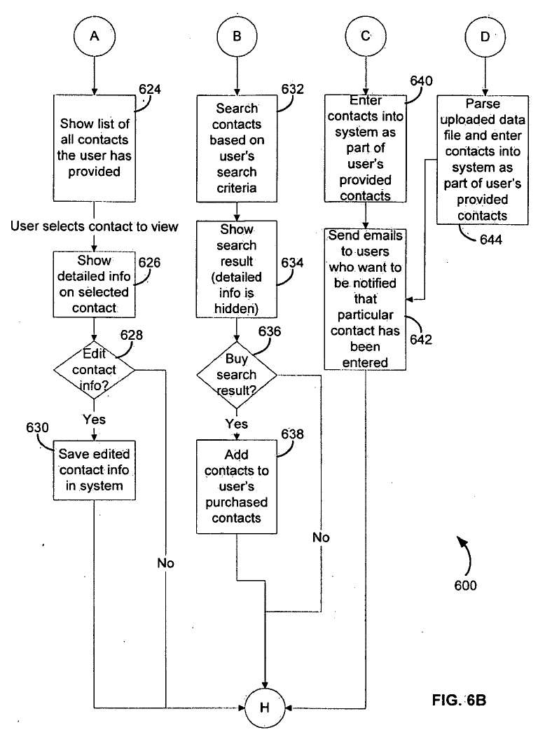

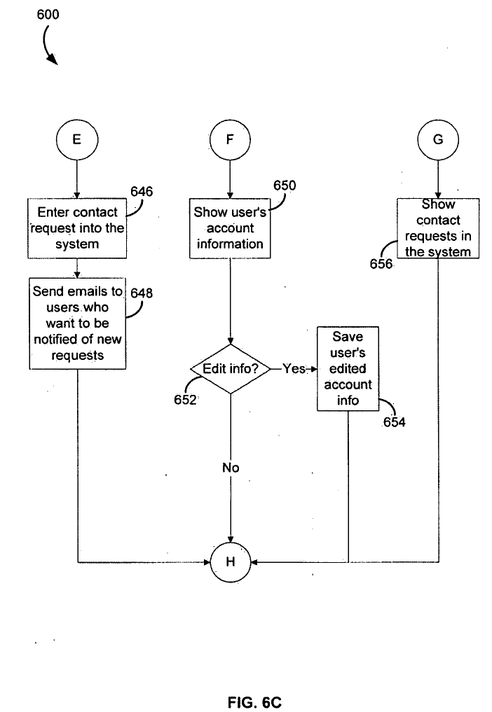

Attention is now directed to FIGS. 6A-6C, which is a flow diagram illustrating an exemplary user flow 600 in a session in an online information marketplace 104 in accordance with some embodiments. For some embodiments, a user 106 may access the online information marketplace 104 via a web browser. For example, the user 106 may type in a Uniform Resource Locator (URL) of the online information marketplace 104 into the web browser. A login/registration page of the online information marketplace 104 is displayed (602). For some embodiments, the login/registration page is displayed as the home page of the online information marketplace 104. In some other embodiments, at the start, a home page of the online information marketplace 104 is first displayed to the user 106 and then the user 106 may navigate from the home page to a login or registration page. From the login/registration page, a first time user 106 of the online information marketplace 104 may register with the online information marketplace 104 and set up an account. Registered users may log in from the login/registration page. For some embodiments, the login/registration page may also provide a mechanism for retrieval of a forgotten username and/or password. Additionally, for some embodiments, the login page and the registration page may be distinct pages. Furthermore, for some other embodiments, the online information marketplace 104 may offer a limited service to unregistered users, where the unregistered users may be allowed to perform a limited search (e.g., search only on particular fields) and view the matching contacts, which may be limited to a predetermined number, for free.

If the user 106 is attempting to register with the online information marketplace 104 (604—Registration), the user 106 may be asked to supply pertinent registration information such as username, password, name, and email address. The user 106 may be further asked to supply other information, such as a mailing address, taxpayer identification number, and so forth. For some embodiments, the email address is also used as the username. The online information marketplace 104 attempts to register the user 106 based on the information supplied by the user 106 (606). If the information is valid (608—Yes), the user 106 is added to the system (610). The user 106 may also be logged in (616) and may begin using the online information marketplace 104. If the information is invalid (608—No), the registration is rejected and the user 106 is taken back to the login/registration page (602), where the user 106 may restart the registration process. For some embodiments, instead of taking the user 106 back to the login/registration page after a rejected registration, the user 106 is notified that one or more items of information supplied for the registration process are invalid and is asked to correct the invalid items of information. For some embodiments, reasons for invalidity include, among others, the supplied username being already taken by another user 106 or the password not satisfying specified criteria (e.g., a minimum length, a requirement to include both letters and numbers).

From the login/registration page, If the user 106 is attempting to log in (604—Login), the user 106 is asked to supply login credentials, such as a username and password. The credentials supplied by the user 106 are checked (612). If the credentials check out (614—Yes), the user 106 is logged in (616) and may begin using the online information marketplace 104. If the credentials do not check out (614—No), the user 106 is taken back to the login/registration page (602) and the user 106 is asked to supply the correct credentials.

After the user 106 is logged in, a navigation page is displayed to the user 106 (618). For some embodiments, the navigation page is one of one or more pages that make up the interface of the online information marketplace 104. The navigation page may be a page from which the user 106 may access other pages and perform various actions in the online information marketplace 104. The interface may include links, forms, and so forth for performing any of several actions. For some embodiments, the user 106 actions include viewing the contact information that has been provided to the online information marketplace 104 by the user 106, searching for and buying contact information, providing contact information by manual entry, automated entry, or file upload, making a request for contact information satisfying specified parameters, logging into a user's networking site, such as Facebook or Linkedin, logging into a user's webmail account, viewing outstanding requests for contact information satisfying specified parameters, viewing account information, or logging out from the marketplace.

If the user 106 action is viewing the contact information that was provided to the online information marketplace 104 by the user 106 (620—View provided contacts), a list of contacts the user 106 has provided to the online information marketplace 104 is displayed to the user 106 (624). The user 106 may select a particular contact from the list in order to view additional information for the selected contact. In response to the selection, the additional information for the selected contact is displayed (626). From here, the user 106 may edit this additional information for the selected contact. If the user 106 did edit the information (628—Yes), the edited information is saved (630). The user 106 may then be taken back to the navigation page (618). If the user 106 did not edit the information (628—No), the user 106 may be taken back to the navigation page (618).

From the navigation page, the user 106 may perform a query for contact information in the online information marketplace 104. The navigation page may provide one or more search boxes that the user 106 may query for contacts; For some embodiments, the navigation page may include search boxes corresponding to particular fields, where the user 106 may enter search terms in order to search on particular fields. In some other embodiments, the user 106 navigates from the navigation page to a search page showing one or more fields for which die user 106 may enter search parameters. If the user 106 action is searching for contacts (620—Search), the contacts in the online information marketplace 104 are searched based on the query entered by the user 106 (632). After the search is complete, the search results are displayed to the user 106 (634).

For some embodiments, the search results show only the number of contacts that match the query parameters, keeping the actual contact information hidden until the user 106 purchases the information. In other embodiments, the search results show only a preview of the contacts that match the query, such as only a limited number of fields (for example, names but not phone numbers or addresses) or complete data for only one or a few of the matching contacts. From the search results display, the user 106 may buy the contact information that matches the query parameters. If the user 106 by the matching contact information (636—Yes), the matching contact information is added to the set of contact information that has been purchased by the user 106 (638). The user 106 may then be taken back to the navigation page (618). If the user 106 does not buy the contacts (636—No), the user 106 may be taken back to the navigation page (618). For some embodiments; the user 106 may also save the search queries for future use. More generally, for some embodiments, a user 106 may create one or more search templates and share the search templates with other users 106. A search template specifies the fields that may be shown in the search page or what search, boxes may be shown in the navigation page.

The user 106 may provide contact information to the online information marketplace 104 by manual entry or by file upload. The navigation page may include a page where the user 106 may enter contact information, which includes values associated with one or more contacts. Also, the navigation page may accept contact information in file formats such as a comma-separated values file (.csv), vCard file (.vcf), and so forth. If the user 106 action is entering contact information manually (620—Enter contact), the entered contact information is stored in the online information marketplace 104 as part of the user's set of provided contacts (640). For some embodiments, a notification may be sent to other users 106 who want to be notified when particular contacts have been entered, if those particular contacts were entered and stored in block 640 (642). Similarly, if the user 106 uploads contacts to the online information marketplace 104 in a file (644), the file is parsed and the contact information included within is stored into the marketplace as part of the user's set of provided contacts (640). A notification may then be sent to other users 106 who want to be notified when particular contacts have been entered, if those particular contacts were entered and stored in block 644 (642). After the notification, the user 106 may be taken back to the navigation page (618). It should be appreciated that, for some embodiments, contact information may be gathered for storage in the online information marketplace 104 via automated processes, such as a web crawler or a direct link to a database.

A user 106 may also make a request for contacts that satisfy specified criteria, rather than merely search for whatever contacts are already available in the online information marketplace 104. That is, the user 106 may make a solicitation of sorts for contacts matching specified characteristics. If the user 106 action is making such a request (620—Request contact info), the request is entered into the system (646). Users who wish to be notified of new requests may be notified (648). For some embodiments, the notification is by email. In some other embodiments, the notification is provided the next time the user 106 who wishes to be notified logs into the online information marketplace 104. The notification allows users 106 to stay abreast of new requests for contact information, to which they can respond by providing contact information that satisfies the requests. After a request, the user 106 may be taken back to the navigation page (618).

A user 106 may view information associated with his account in the online information marketplace 104 (620—View account info). The user's account information is shown to the user 106 (650). If the user 106 edits the account information (652—Yes), the edited account information is stored in the online information marketplace 104 (654). If the user 106 does not choose to edit his account information (652—No), or after the user 106 is finished editing his account information, the user 106 may be taken back to the navigation page (618).

A user 106 may view outstanding requests or solicitations for contacts that satisfy specified criteria (620—View Contact Requests). Outstanding contact requests are presented to the user 106 (656). The user 106 may also add to or comment on an outstanding request. Afterwards, the user 106 may be taken back to the navigation page (618).

When the user 106 is finished, the user 106 may log out (620—Log Out). The user 106 is logged out (622), completing the session. If the user 106 wishes to reenter the online information marketplace 104, the user 106 may navigate to the login page (602) and log in.

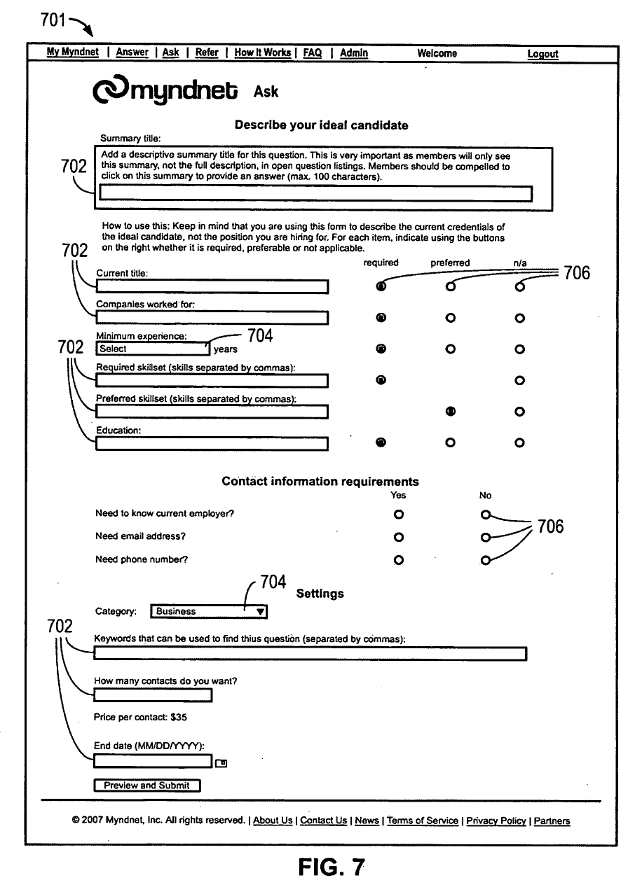

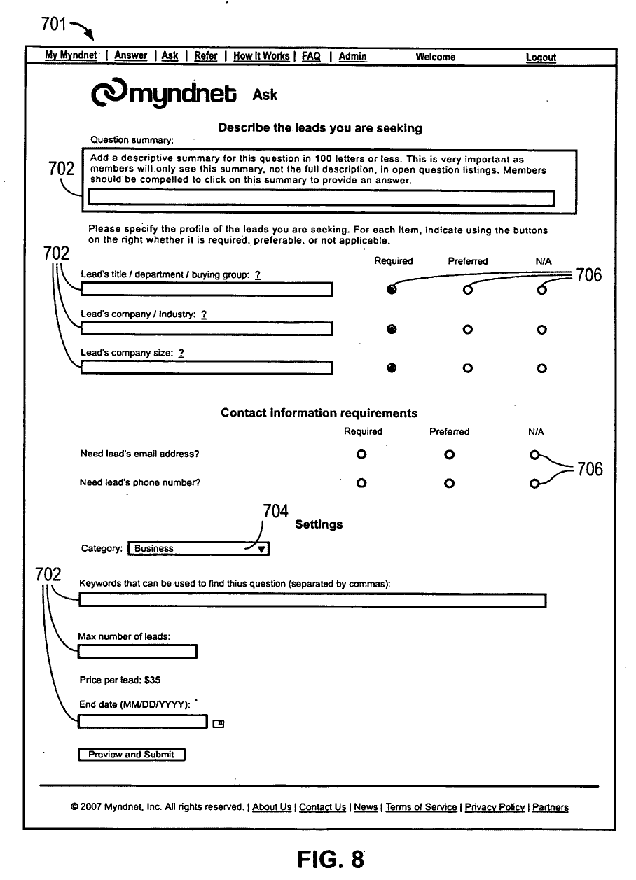

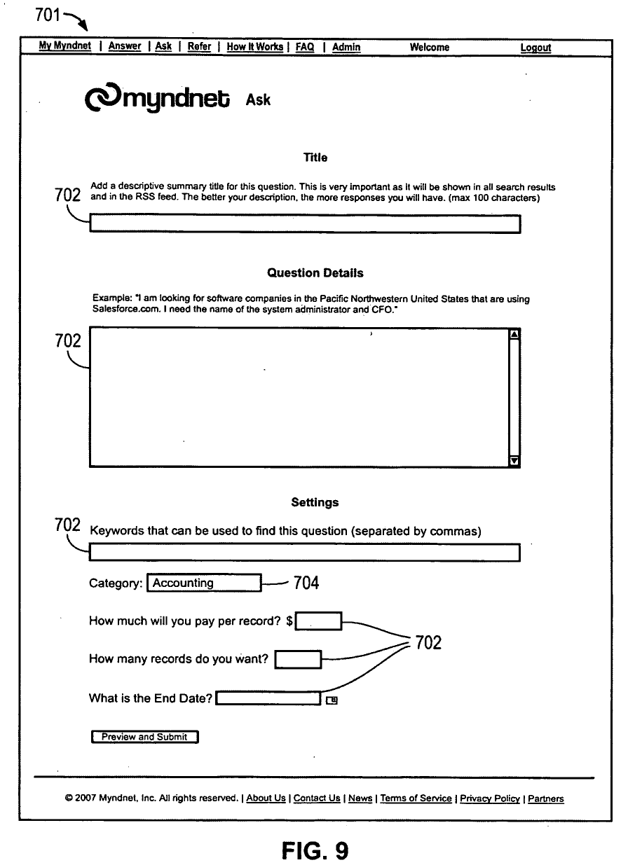

For some embodiments, a user 106 may request information, such as contact information, using a structured form 701. Similarly, a; user 106 may submit information using a structured, form 701. FIGS. 7, 8, and 9 illustrate embodiments of structured forms 701 used to request information. Specifically, FIG. 7 is an embodiment of a structured form 701 for a user 106 to request recruitment information. FIG. 8 is an embodiment of a structured form 701 for a user 106 to request business development and sales related information. FIG. 9 is an embodiment of a structured form 701 used to request marketing leads.

A structure form 701 may include text fields 702, Text fields 702 may be used for a user 106 to type data into a structured form 701. A structured form 701 may also include selectable lists 704 that a user 106 may select from categories, tides, names, or any other type of information that the user 106; is interested in obtaining. For example, a selectable list 704 may be in the form of a drop down box, a window including a scrollable list, and/or a list of any other format. For some embodiments, a structure form 701 includes selectable areas 706 to designate requirements for information that is requested. For example, a selectable area 706 such as a radio button, toggle button, or a check box may be used to designate that information in an area is required, preferred, or not applicable. Furthermore, a selectable area 706 may indicate if information is required by the user 106 requesting the information.

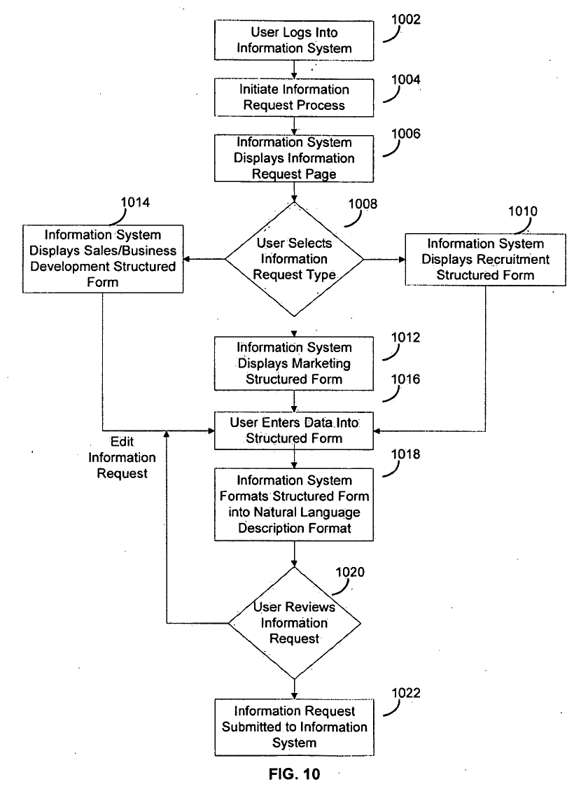

For some embodiments, online information marketplace 104 generates a natural language information request from information gathered from a structured form 701. In other words, some embodiments of an online information marketplace 104 convert information entered into a structured form 701 and translate this information into a format to use as an information request to send to a user 106. Some embodiments use a context-free grammar such as Backus-Naur form (BNF), Augmented BNF, Extended BNF, Panini-Backus or other context-free grammar to convert a structured form 701 into natural language. FIG. 10 illustrates an embodiment of a process flow of a user 106 entering an information request using a structured form 701 and the system converting the information request in the structured form 701 into a natural language information request.

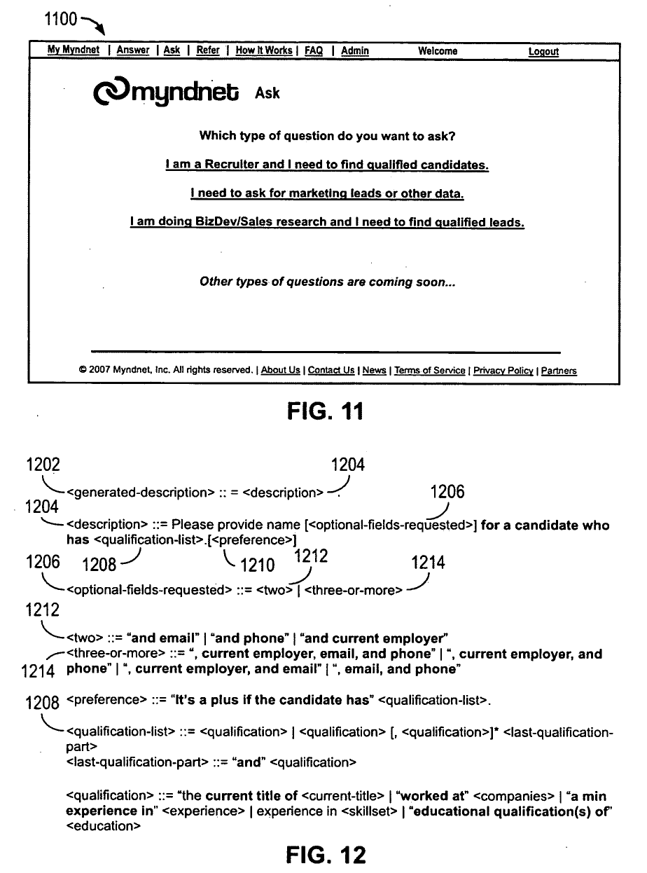

For the FIG. 10 embodiment, a user 106 logs into online information marketplace 104 at block 1002. Once logged into an online information marketplace 104, a user 106 initiates the information request process by clicking or selecting on an ask tab or button (1004). The user 106, who is buying information, is then directed to an ask page 1100. FIG. 11 illustrates an embodiment of an ask page 1100 for an online information marketplace 104. At block 1008, a user 106 selects the type of information request the buyer would like to make. For an embodiment, a user 106 is directed to a structured form 701 responsive to the user's selection. For the FIG. 10 embodiment, a user 106 is directed to a marketing leads structured form if the user 106 selects recruitment (1010). Alternatively, a user 106 is directed to a recruitment structured form if the user 106 selects marketing leads (1012). For an embodiment illustrated in FIG. 10, a user 106 may also select business development information and be directed to a business development structured form (1014).

After a structured form 701 is displayed to a user 106, the user 106 enters data into the structured form 701 (1016). For example, a user 106 enters data into a text field 702, selects a selectable area 706, and/or selects data in a selectable, list 704. The data entered into a structured form 701 is then formatted into a natural language description format (1018). For some embodiments, online information marketplace 104 formats the data entered into a structured form 701 using Backus-Naur form (BNF). Thus, these embodiments of the online information marketplace 104 use a set of rules to take the data entered by the user 106 into the structured form 701 to format this data into a defined output, such as a natural language, description format. FIG. 12 illustrates an embodiment of BNF grammar for creating a natural language description from a structured form 701 used to request recruitment information.

An online information marketplace 104 may determine the value of <generated-description> 1202 for an information request according to the rules set out in the FIG. 12 example. According to the rules set out in FIG. 12, the value of <generated-description> 1202 equals <description> 1204, Moreover, <description> 1204, as defined in the FIG. 12 example, is equal to Please provide name [<optional-fields-request>] for a candidate who has <qualification-list>[<preference>]. Thus, to complete the <description> 1204 the online information marketplace 104 needs to determine the value of the variable <qualification-list> 1208. Variables <optional-fields-requested> 1206 and <preference> 1210 are optional as indicated by the square brackets around those variables. For some embodiments, the online information marketplace 104 uses information received from a structured form 701 to determine the value of the variables.

To resolve the value of the variable <optional-fields-requested> 1206, according to some embodiments, the online information marketplace 104 takes user input received from a structured form 701 that is associated with the variables needed to determine the value of <option-field-requested> 1206. Referring back to the FIG. 12 example, <option-field-requested> 1206 is defined as either the value of <two> 1212 or the value <three-or-more> 1214 (the or is illustrated by the character | in FIG. 12 as seen between the variables <two> 1212 and <three-or-more> 1214). The value of <two> 1212 as defined in the FIG. 12 example is “and email” or “and phone” or “and current employer.”

Thus, a structured form 701 may have an input associated with one of the possible values of <two> 1212. For example, a user 106 may select a selectable area 706 associated with “and email.” This would make the value of <two> 1212 to be equal to “and email.” In turn, this value, “and email,” would be the value of <optional-fields-requested> 1206, as defined in FIG. 12. So, the <optional-fields-requested> 1206 variable in the <description> definition would be replaced with “and email.” The value of <description> 1204 is now known to be Please provide name and email for a candidate who has Qualification list>. [<preference>]. The online information marketplace 104 would then determine the value of Qualification list> 1208 and optionally <preference> 1210 to determine the complete value of <description> 1204 similar to the procedure described above for the Variable <optional-fields-requested> 1206. The online information marketplace 104 would then use this information to form the generated description for an information request, according to some embodiments.

Once online information marketplace 104 creates a natural language description from a structured form 701, the user 106 may review the information request (1020) and then submit the information request to online information marketplace 104 (1022).

For some embodiments; online information marketplace 104 matches an information request submitted to one or more users 106. This targets information requests to users 106, such as information sources 102, who are more likely to be able to provide information responsive to a particular information request. An online information marketplace 104 may match an information request to one or more users 106 by using past information submissions of a user 106 to create an information signature. For example, an online information marketplace 104 may determine an information signature based on data including categories of information submitted, frequency of submitting information on a subject area, keywords from information requests that a user 106 submitted or responded to, a member profile of a user 106, volume and frequency of submitting information, ratings of a user 106, or any other data. Furthermore, online information marketplace 104 may use one or more of the above data categories to determine a user 106 or group of user 106 that might have information for a submitted information request.

For some embodiments, online information marketplace 104 matches an information request to a user 106 by comparing information signatures to data or keywords in an information request. If a user's information signature contains similar data or keywords as the information request, an online information marketplace 104 notifies the user 106 of the information request. Ah online information marketplace may notify a user 106 by e-mail, RSS feed, remote interface 301, notifying user 106 upon login to the online information marketplace 104, or any other method.

Another method used to match an information request to/a user 106 includes creating an information request signature. An embodiment of an information system may break down different components of an information request entered into the online information marketplace 104 to/generate an information request signature. For example, an online information marketplace 104 disassembles different fields of an information request and assigns weights to some or all of the fields to create an information request signature.

Therefore, for some embodiments, a user 106 that has information in a member profile that corresponds to one or more categories used to define an information request signature would receive alerts or notification from online information market place 104 about a the corresponding information request. For other embodiments, an information request signature may be compared to a user's information signature.

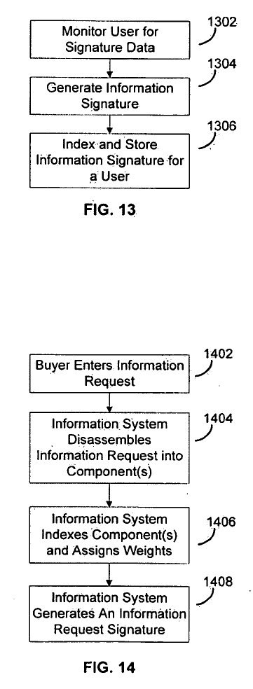

FIG. 13 illustrates an embodiment of a process flow for generating an information signature. For some embodiments, online information marketplace 104 monitors a user 106 for signature data (1302). Once an online information marketplace 104 collects data on a user 106, online information marketplace 104 generates an information signature based on techniques discussed above (1304). An online information marketplace 104 then stores the generated information signature in a database 212. For some embodiments, online information marketplace 104 updates an information signature of a user 106 as new data is collected on a user 106. For example, the information signature of a user 106 is updated upon receiving an information submission from the user 106 or receiving rating information on the user 106. Thus, as data about a user 106 is collected by the online information marketplace 104, the online information marketplace 104 uses this data to update the information signature for that user 106.

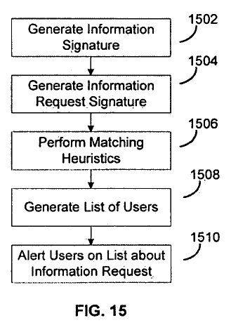

As discussed above, some embodiments of an online information marketplace 104 generate an information request signature from an information request submitted. FIG. 14 illustrates an embodiment of a process flow for generating an information request signature. A user 106 submits an information request (1402). An embodiment of an online information marketplace 104 disassembles the information request into one or more components (1404). Components may include type of information request, data on user 106 that submitted the information request, category of information request, and. An online information marketplace 104 indexes the various components and assigns weights to one or more of the components (1406). Information system 206 then uses the components and weights to generate an information request signature (1408).

A weighted summation method, as discussed in detail below, may be used to generate an information request signature. Other methods to generate an information request signature based on assigning weights to components may include one or a combination of using ratios, statistics, or other heuristics to characterize an information request.

Some embodiments of an online information marketplace 104 also, match information requests: with a user 106 using matching heuristics. FIG. 15 illustrates an embodiment of a process flow using matching heuristics. As shown in FIG. 15, online information marketplace 104 creates an information request signature for an information request (1502). Information system 206 also generates one or more information signatures, as discussed above (1504). At block 1506 in the process flow, online information marketplace 104 performs matching heuristics by comparing an information signature with one or more information signatures. An online information marketplace 104 then generates a list of users 106 that are likely, able to provide information responsive to an information request (1508). Once the list of users 106 is generated, information system 206 alerts users 106 on the list about the information request (1510). For example, information system 206 alerts users 106 through e-mail, RSS feed, a remote interface 301, or any another communication technology.

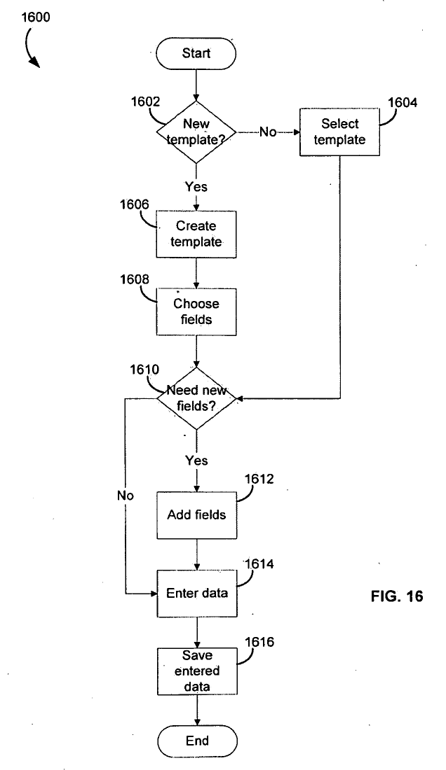

Attention is now directed to FIG. 16, which illustrates a process flow 1600 for providing information to an online information marketplace 104 in accordance with some embodiments. When the user 106 wishes to provide information associated with a contact, the user 106 may enter values for one or more mandatory fields and any number of other fields. For some embodiments, the user 106 may specify which fields are shown in the data entry form via templates. Each template specifics the fields that are shown to the user 106 at the information entry page.

When the user 106 wishes to enter contact information into the marketplace, the user 106 may be asked if he wishes to create a new template or use an existing template. If the user 106 wishes to use a new template (1612—Yes), the user 106 creates a new template (1606) and chooses the fields for that template (1608). If the user 106 wishes to use an existing template (1602—No), the user 106 may select an existing template (1604).

Whether the user 106 creates a new template or uses an existing template, the user 106 may need additional fields not already in the template. If the user 106 needs additional fields (1610—Yes), the user 106 may add one or more additional fields (1612). For some embodiments, the user 106 may also remove one or more fields. After additional fields are added, or if the user 106 does not wish to add additional fields (1610—No); the user 106 proceeds to enter values for the fields (1614). When the user 106 is finished and submits the values, the entered values are saved (1616).

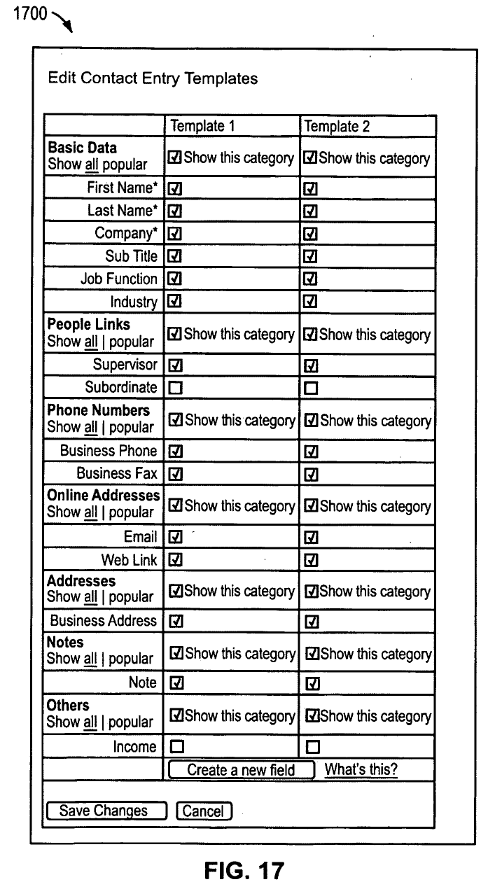

The user 106 may also edit a template by navigating, for example, to a template editing form 1700 (FIG. 17). A template editing form allows the user 106 to enter a name for a template, select categories of fields and individual fields for inclusion in the template, and add or create fields for a template.

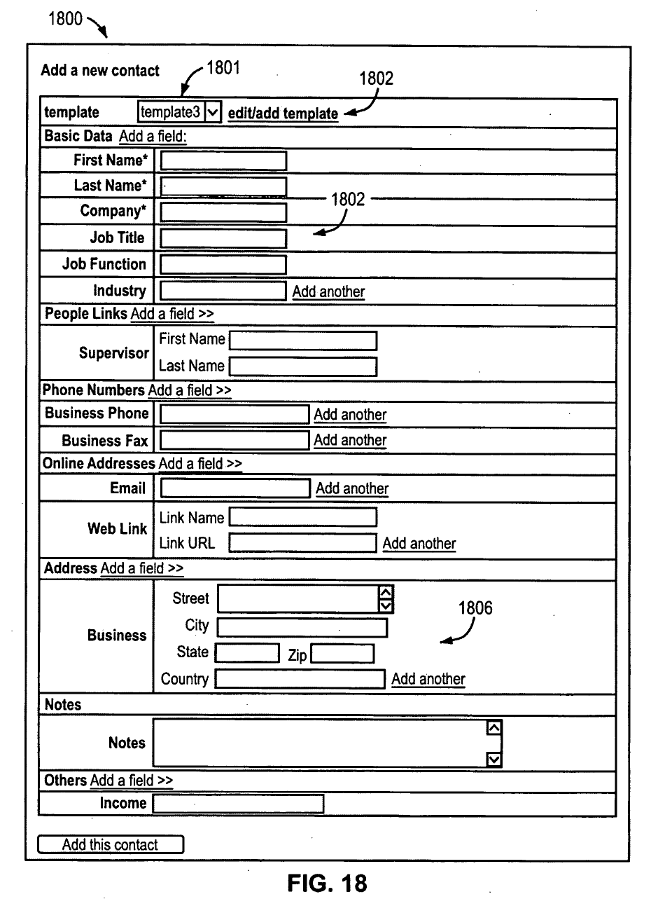

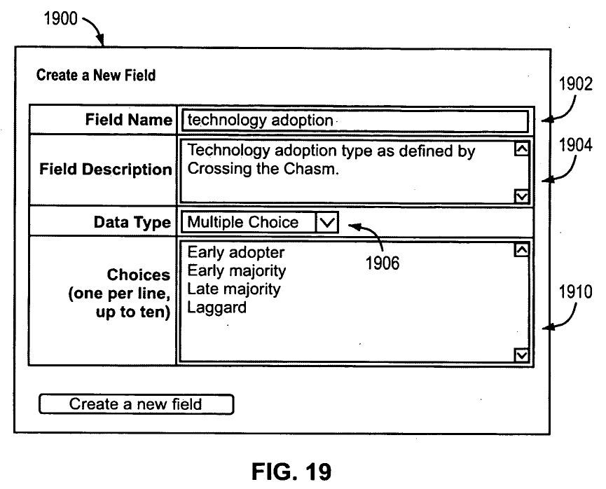

Attention is now directed to FIGS. 18-19, which illustrate exemplary interfaces for providing information associated with a contact to the online information marketplace 104 in accordance with some embodiments. For some embodiments, the interface for providing contact information in the online information marketplace 104 includes ah information entry form 1800 in a web page. The information entry form 1800 may include a menu 1801 for selecting an existing template and a link 1802 for navigating to a page where, templates may be added or modified.

The information entry form 1800 also includes text boxes 1804 for one or more fields. The user 106 may enter a value for a field in the text box corresponding to that field. The entry form includes both fields provided by the online information marketplace 104 and custom, user-defined fields adopted by the user 106. For some embodiments, a field may have sub-fields. For example, a field “Business Address” 1806 may have sub-fields such as “Street,” “City,”; “ZIP,” and so forth, corresponding to components of the information that make up a business address.

From the information entry form 1800, the user 106 may choose to add a custom, user-defined field. For some embodiments, the interface for creating a user-defined field is a form 1900 on a web page. The custom field form 1900 includes a box 1902 for entering a field name and a data type menu 1906 for selecting a data type. The custom field form 1900 may also include a box 1904 for entering an optional description of the field to be created. The custom field form 1900 may also include one or more additional boxes 1908 for entering additional data related to the custom field. The additional box(es) 1908 may or may not be present, depending on the data type selected by the user 106. For example, in FIG. 19, the data type “Multiple Choice” is selected in the data type menu 1906. The custom field form 1900 includes a box “Choices” 1908 for entering the values from which the user 106 may choose for the corresponding field.

User-defined fields that are created may be saved in the database 212 of the marketplace. Furthermore, they may be opened up to other users 106 so that the other users 106 may make use of the user-defined fields when providing or searching for contact information; the user-defined fields are not kept private. For some embodiments, the field name box 1902 may include an auto-complete feature that auto-completes whatever string that is typed into the box with names of existing fields. When a user 106 enters information into user-defined fields, some embodiments of the online information marketplace 104 may search through a list of previously inputted entries to match a users' partial entry to return a possible match for the complete entry. The online information marketplace 104 may then provide a list of possible complete entries to a user 106 from which to select. For some embodiments, the online information marketplace 104 may store past entries made by a user 106 locally on a client 202, such as a local cache. The online information marketplace 104 or an application running locally on the client 202 may search through this list upon receiving a partial entry from a user to determine a possible complete entry. For some embodiments, a possible match is selected if the partial entry matches a portion of a previously stored, entry. Alternatively, for other embodiments, the online information marketplace 104 may store previous entries made by a user in a database 212 remote from a client 202. Additionally, for some embodiments, there may be user-created fields that the user/creator may keep private or share with a limited set of users 106.

Custom, user-defined fields extend the process of providing contact information beyond merely filling a predefined form. Users 106 can add as many fields as needed in order to provide information that is not covered by the predefined fields. The user-defined fields make the information entry process a freeform data entry process that gives users 106 great flexibility in providing various types of information to the online information marketplace 104.

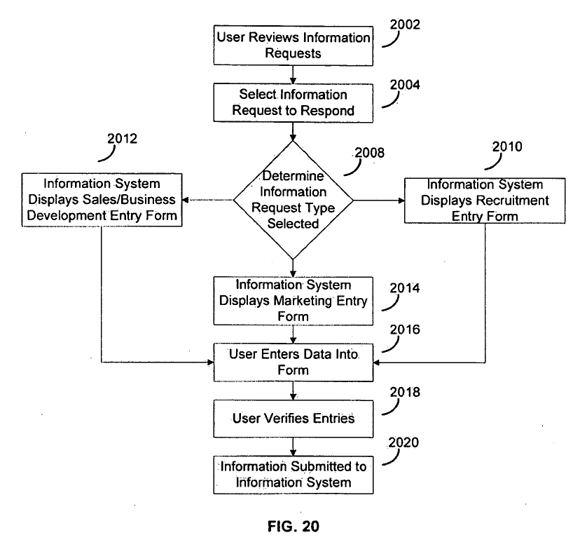

For some embodiments, an online information marketplace 104 also assesses the quality of information submitted by a user 106. Quality of information may refer to the accuracy of the information, the likelihood of accuracy of the information, whether the information is up to date, the likelihood the information is up to date, whether the information is responsive to an information request, and the general usefulness of information. FIG. 20 illustrates an embodiment of a process flow for an online information marketplace 104 that requires a user 106 to verify that the information the user 106 submits is responsive to the information request. For some embodiments, a user 106 reviews any requests for information (2002) on an online information marketplace 104. A user 106 may review any information requests by any method for viewing information or data on a server, such as browsing or searching through information requests, receiving an e-mail containing a request for information, receiving an RSS feed including one or more information requests, and viewing any information requests oh a remote interface 301.

The user 106 selects an information request for submitting information to an online information marketplace 104 (2004). At 2008 in FIG. 20, an embodiment of an online information marketplace 104 determines the type or category of an information request that a user 106 selects. For some embodiments, an online information marketplace 104 determines the type of information request that a user 106 selects based on a code embedded in an information request that the user 106 selects. For an embodiment, a code may represent a specific information request type or represent an information request. A code may be any alphanumerical combination including a Uniform Resource Locator (URL), an information request identifier, an e-mail identifier, a remote interface identifier, or any other identifier. Alternatively, a user 106 may manually input the information type. Information request types include recruitment information, sales information, business development information, marketing information, and any other subject of information.

Based on the type of information request a user 106 selects, an online information marketplace 104 displays different entry forms. For some embodiments, an entry form is dynamically created by an online information marketplace 104 based on information entered into a structured form 701 used to create the information request. For some embodiments, the online information marketplace 104 assigns a data entry method to information entered into a structured form 701. A data type, for some embodiments, is associated with a respective data entry method. For example, an area of a structured form 701 designated as a request for contact information may be associated with a text field 702 and formatted to create an entry form that provides a text field 702 for an information source 102 to enter the requested contact information. Moreover, the data type on a structured form 701 may be similarly associated with other input methods including but not limited to a selectable list 704, selectable area 706, or other method for entering information on a webpage or interactive form. Data types may include text (length-limited or not), number (e.g., integer, float), number range, name, address; date, date range, multiple choice, contact information, credential information, verification information, preferred information, required information, or other categories of data a user might request from an information source 102. Thus, to create an answer form, some embodiments convert the information entered into a structured form 701 into natural language description format, as discussed above, associate a data entry method to each data type, and format this into an interface for an information source 102 to enter information responsive to the associated information request.

Alternatively, a user 106 may input information by sending an e-mail, inputting information into a data structure, or using any other method to provide information to an online information marketplace 104.

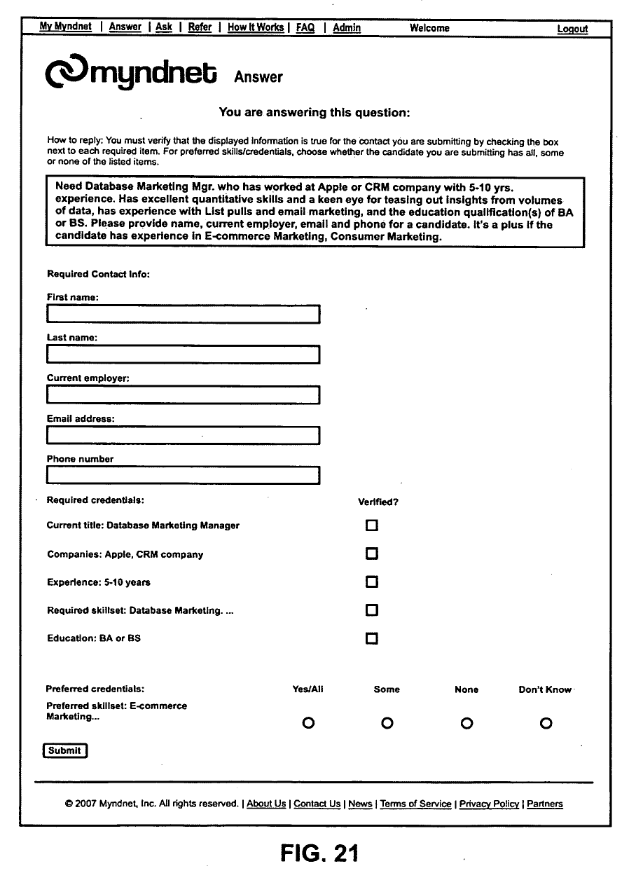

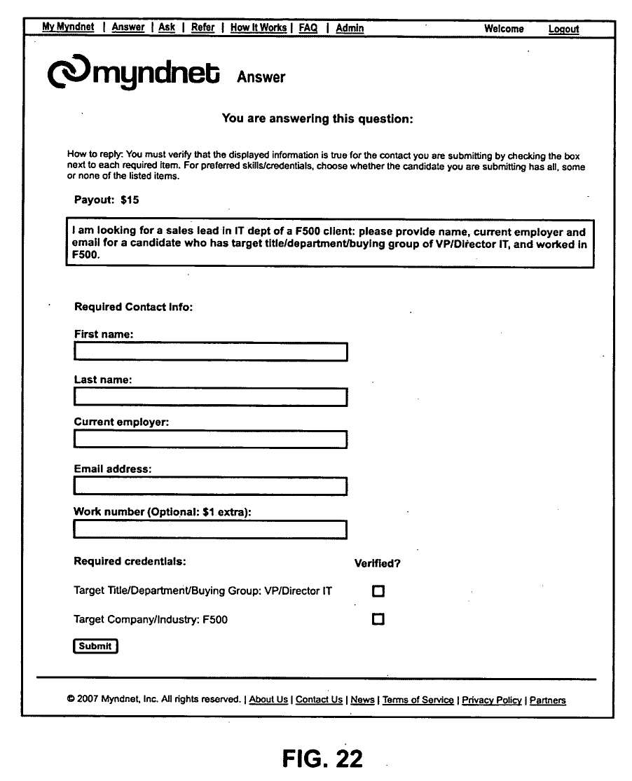

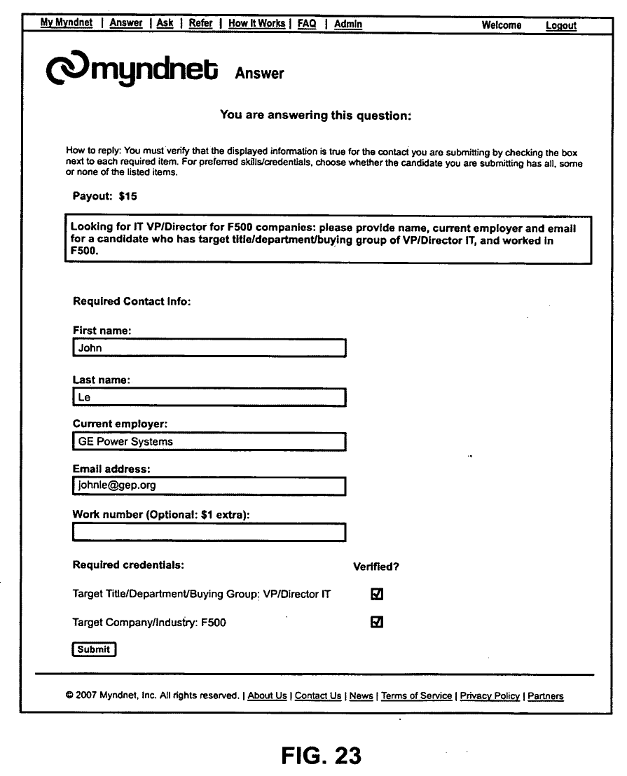

As illustrated in FIG. 20, online information marketplace 104 displays a recruitment form, such as that illustrated in FIG. 21, for a recruitment submission (2010), a sales/business development form, such as that illustrated in FIG. 22, for a sales and business development information submission (2012), and a marketing, form, such as that illustrated in FIG. 23, for a marketing information submission (2014). A user 106 then enters data into a form to submit information responsive to an information request (2016). To ensure quality of the information submitted, a user 106 verifies the information that is submitted (self verification). Other embodiments include a question on an entry form for which the online information marketplace 104 already has a verified answer. If a user 106 provides the correct answer, the submission responsive to an information request is considered to be a higher quality than one for which that a user provides an incorrect answer. For another embodiment, if a user provides an incorrect answer, the submission is discarded and the user receives no credit for the submission.

For some embodiments, an online information marketplace 104 requests that an information source 102 confirm that information required or preferred by a user 106 requesting the information is included in die submission. To verify information, an information source 102 may select an area on a form indicating that information is included and correct. Once an information source 102 completes entering information into a form, the information source 102 submits the information to an online information marketplace 104 (2020).

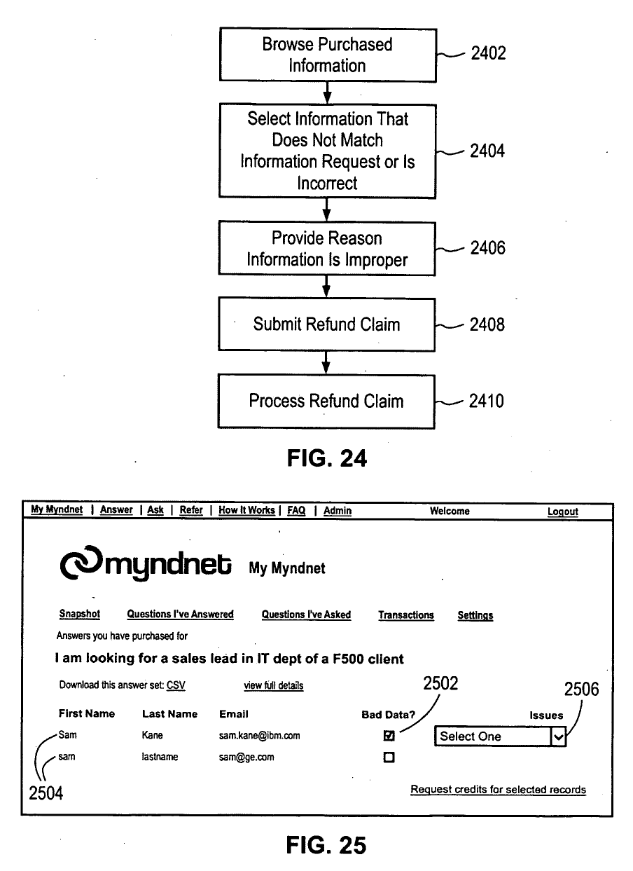

For some embodiments, online information marketplace 104 manages the quality of information submitted based on verification by a user 106 who buys the information (self verification). FIG. 24 illustrates a process flow of a method for a buyer to verify the quality of information purchased according to an embodiment. A user 106 who purchased information logs into an online information marketplace 104 to browse through the purchased information (2402). The user 106 then selects the information, provided by an information source 102 that does not match the information request, is incomplete, or is not correct.

FIG. 25 illustrates an embodiment of a screen that an information buyer might use to report that the information provided by an information source 102 does not match the information request, is incomplete, or is incorrect. As illustrated in FIG. 25, a user 106 may select from a bad data indicator 2502 associated with the information source 102 identifier 2504 for the information source 102 that provided information that did not match the request, that was incomplete, or that provided incorrect, information. Furthermore, a user 106 may provide a reason explaining why the information does not match, is incomplete, or is incorrect. For some embodiments; a user 106 may select a reason using an issue selection list 2506 (2408). Once an information buyer submits this information (2408), online information marketplace 104 processes a refund for any payment made by the information buyer for the information that did not match an information request, that was incomplete, or that was incorrect (2410).

To further ensure the quality of information submitted by an information source 102, some embodiments use seller ratings. A seller rating may be determined using data collected about an information source 102 including the number of times an information source 102 submitted information, the number of users 106 who purchased information from an information source 102, the number of times an information source 102 has provided information that did not match an information request; that was incomplete, or was incorrect, the frequency of overall usage of an online information marketplace 104 by an information source 102 (i.e. selling and buying of information), the duration of membership with an online information marketplace 104, or any other data regarding an information source 102. For some embodiments, a seller rating may be used to determine the compensation to provide to a user submitting information, to penalize an information source 102 for providing information that did not match an information request, was incomplete, or was incorrect, and for any other use.

An online information marketplace 104 may also use a weighed summation method to determine a rating. One such weighted summation method would assign a weight value for a category of data, such as those listed above, based on the importance for gauging the overall quality of an information source 102 and add the resulting values together to determine a rating. For example, data representing the number of times an information source 102 provided incorrect information may be assigned a weight of a minus two, the number times an information source 102 provided improper information may be assigned a weighed of minus one, number of buyers that purchased information from an information source 102 may be assigned a weight of two, and the duration, of membership may be assigned a weight of 0.5. Therefore, for an information system 206 determining a rating for an information source 102 just, on the above data based on a buyer who provides incorrect information once, improper information never, has five information buyers purchase any information provided, and has a membership for two years, an embodiment of an information system 206 using the above weighting would determine that the information source 102 has a rating of ((−2)−(1)+(−1)·(0)+2·(5)+0.5·(2))=9.

The above example is one of many methods that may be used to determine a rating of an information source 102. Other methods used may include one or a combination of ratios, statistics, or other heuristics based on data collected on an information source 102. For some embodiments, an information system 206 determines a rating responsive to data collected. Seller ratings also may be used by an information system 206 to determine the value of any information submitted by an information source 102. Moreover, the seller rating can be used to determine how much an information source 102 is compensated for any submitted information. For example in some embodiments, the higher the seller rating of an information source 102 the higher the value of the information. Likewise, for some embodiments, the higher the seller rating, the information source 102 is entitled to a larger amount of compensation when a user 106 purchases the information submitted by the information source 102.

Furthermore, the rating system described above for an information source 102 may be applied to a user 106 who purchases information to generate a buyer rating. For an embodiment, such a feature is called arbitration. Data used by an online information marketplace 104 to determine a buyer rating for a, user 106 may include the number of information requests submitted; the number of times a user 106 purchased, information from an information system 206, the number of times a user 106 challenges ah information source 102, how often an information buyer uses online information marketplace 104 (i.e. selling and buying of information), the size of a referral network, the duration of membership, and any other data collected on a buyer. For some embodiments, a buyer rating may be used to determine the cost of information for an information buyer, penalize an information buyer for improperly marking an information source 102 as providing information that did not match an information request, that was incomplete, or that was incorrect, and for any other use.

For some embodiments, the online information marketplace 104 provides qualified business opportunities (QBO) to users 106; Access to qualified business opportunities may be a way for a business to improve their sales closure rate. Qualified business opportunities may be used for obtaining verified contact information acquiring new customers, recruiting hard to fill job positions, finding experts in any technology or industry, acquiring market research, acquiring sales information, marketing, or obtaining information for product development purposes. Verified contact information collected along with qualified business opportunities may be used to improve the effectiveness of marketing campaigns targeted to different profiles. Often, businesses expend many resources to acquire qualified business opportunities and verified contact information. However, the use of certain embodiments of the online information marketplace 104 reduces the resources need for a business to acquire qualified business opportunities because, of me efficiencies built in to the network and the diverse network of information sources 102.

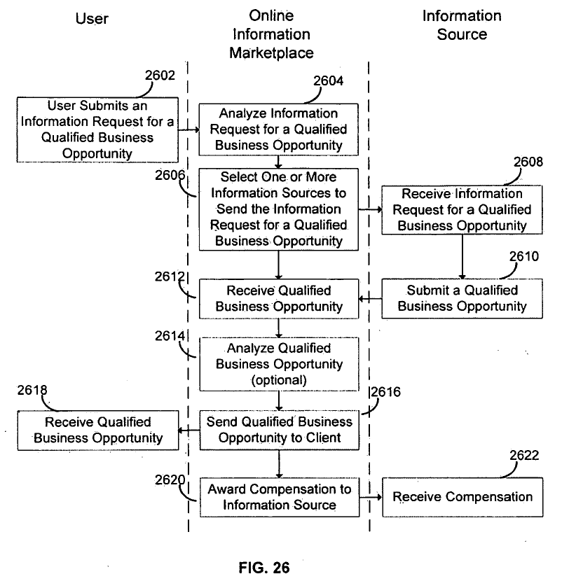

FIG. 26 illustrates an embodiment of a process flow for obtaining a qualified business opportunity. A user 106 may submit an information request for a qualified business opportunity to the online information marketplace (2602). The information request for a qualified business opportunity, according to some embodiments, may be submitted using methods discussed above for submitting an information request.

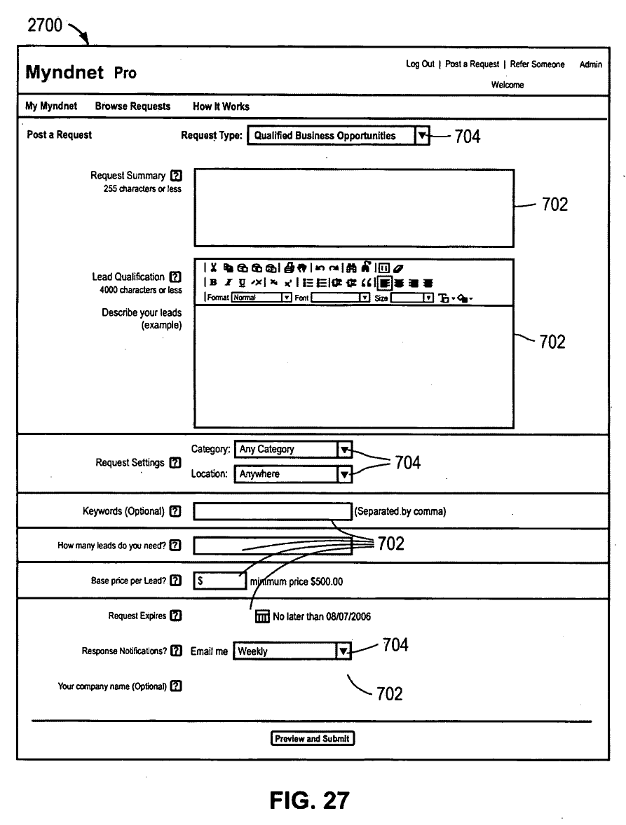

For example, FIG. 27 illustrates a structured form 701 that a user may use to submit an information request to specify criteria for a qualified business opportunity. The qualified business opportunity request form 2700 illustrated in FIG. 27 includes text fields 702 for a user 106 to specify criteria that the qualified information opportunity should include. Moreover, the qualified business opportunity request form 2700 may include selectable lists 704 to specify criteria including how the user 106 should be notified of a submitted qualified business opportunity.

At block 2604 of FIG. 26, the online information marketplace 104 receives the information request for a qualified business opportunity from the user 106 and analyzes the received information request. The analysis, according to some embodiments, may include determining any categories and/or areas of interests that a user 106 selected. For example, a user may select tags on a submission form that indicates the categories and/or areas of interest for which the information request relates.

Moreover, some embodiments may use one or more keywords submitted by the user 106 who submitted the information request to determine any categories and/or areas of interests for which the information request relates. For some embodiments, the online information marketplace 104 analyzes the text of an information request for a qualified business opportunity to determine the categories and/or areas of interest for which the information request relates. Such an analysis may search for predefined keywords within the information request to determine the categories and/or areas of interest. Another technique used to analyze the information request for a qualified business opportunity includes using an information signature, as discussed above, of the user 106 who submitted the information request to determine any categories and/or areas of interest for which the information request relates. Some embodiments may use one or more of the techniques discussed above to determine the categories and/or areas of interest of an information request for a qualified business opportunity.

Once the online information marketplace 104 analyzes the information request for a qualified business opportunity, some of the embodiments of the online information marketplace 104 use the related category and/or areas of interest information to select one or more information sources 102 to send the information request (2606). For some embodiments, the online information marketplace 104 selects one or more information sources 102 based on information in a member profile of the information source 102 that matches the determined categories and/or areas of interest selected by the user 106.

For example, a member profile of an information source 102 may include tags for an information source 102 to select areas of expertise. These areas of expertise may include industries or segments of industries for which an information source 102 has contacts. For some embodiments, an information signature of an information source 102 may be used to determine the areas of expertise of that information source 102 and if the information source 102 has the background to respond to the information request.

For some embodiments, an information source 102 may maintain a contacts database with the online information marketplace 104. For example, an information source 102 may upload a list of contacts to the online information marketplace 104 such as a contact list related to professional networks, social networks, or other sources where a contact list is maintained. Thus, certain embodiments of the online information marketplace 104 analyze a contact list of an information source to determine if a submitted information request relates to any of the contacts. If the online information marketplace 104 determines a match between an information request and a contact, of a user 106, the online, information marketplace may notify the user 106 of the information request. Moreover, one or more of the techniques described above may be used to select one or more information sources 102 for which to send an information request.

Having selected one or more information sources 102 that have the area of expertise relevant to the information request for a qualified business opportunity, the one or more information sources 102 receive the information request (2608). An information source 102 may receive an information request for a qualified business opportunity through e-mail, RSS feed, remote interface 301, web portal, widgets on a website, or any other method of receiving information. An information source 102 may then submit a qualified business opportunity (2610) relevant to the information request. An information source 102 may submit a qualified business opportunity by any method known for submitting data, including those methods discussed herein, and including but not limited to structured forms, e-mail, and uploading documents.

Alternatively, an information source 102 may browse through a list of information requests on a web page, RSS feed, remote interface 301, widgets on a webpage, or a blog. Therefore, an information request for a qualified business opportunity need not be selected by an online information marketplace 104 for an information source 102 for a user 106 to respond to an information request. For some embodiments, when an information source 102 submits a response to an information request, the category and/or area of interest of the information request is added as an area of expertise for that information source 102. For example, this information may be added to a member profile. For certain embodiments, an information source 102 must be registered in order to submit a response to an information request for a qualified business opportunity. However, for other embodiments, the user 106 need not be registered to respond to a request for a qualified business opportunity.

For some embodiments, the online information marketplace 104 provides closed loop prospecting. For example, an information source 102 may include in the submission a request for a confirmation from a contact or prospect to verify the intent to engage in the associated qualified business opportunity. Certain embodiments of the online information marketplace 104 include a check box on a structured form 701 that an information source 102 may select to request this confirmation. The online information marketplace 104 may then notify the contact associated with the qualified business opportunity of the request to confirm the intent to engage in the opportunity. Such a notification may be through any form of communication including but not limited to e-mail, RSS feed, remote interface, widget on a web page, and interface on a web portal. For some embodiments, a user 102 may require in an information request that the qualified business opportunity must, include such a confirmation. In some embodiments, an information resource 102 may receive additional compensation for including

Once the online information marketplace 104 receives a qualified business opportunity (2612), the online information marketplace 104 optionally analyzes the submission. For some embodiments, the online information marketplace may analyze the qualified business opportunity to ensure that the submission meets the criteria that the user 106 requested. In addition, the online information marketplace 104 may analyze the qualified business opportunity for keywords to determine the area of expertise for an information source 102. Furthermore, this analysis may be used to generate a seller rating for the information source 102, as discussed above.

Having received the qualified business opportunity and optionally analyzing it, the online information marketplace 104, sends the qualified business opportunity to the user 106 that submitted the information request (2616). Alternatively, an online information marketplace 104 may notify the user 106 that a qualified business opportunity is available. Such notification may be an e-mail, a message received upon login to a web account, a text message, RSS feed or any other type of communication.

The online information marketplace 104 then awards compensation to the information source 102 for the submission (2620). Some embodiments of the online information marketplace 104 award compensation to an information source 102 as a percentage of any fees collected from a user 106 for submitting the information request. Other embodiments may award compensation to an information source 102 as a predetermined fixed fee for submission of a qualified business opportunity. Yet, other embodiments award compensation based on any sales generated, from the qualified business opportunity. For example, an information source 102 may be awarded a percentage of the sales generated over a period of time. In addition, some embodiments may award compensation to an information source 102 based on a combination of the compensation schemes address above.

After a user 106 receives a qualified business opportunity responsive to a submitted information request, the user 106 may reject the qualified business opportunity. For some embodiments, a user 106 may reject a qualified business opportunity because it did not meet the criteria in the information request, the contact information was incorrect, or another defect in the qualified business opportunity is found.

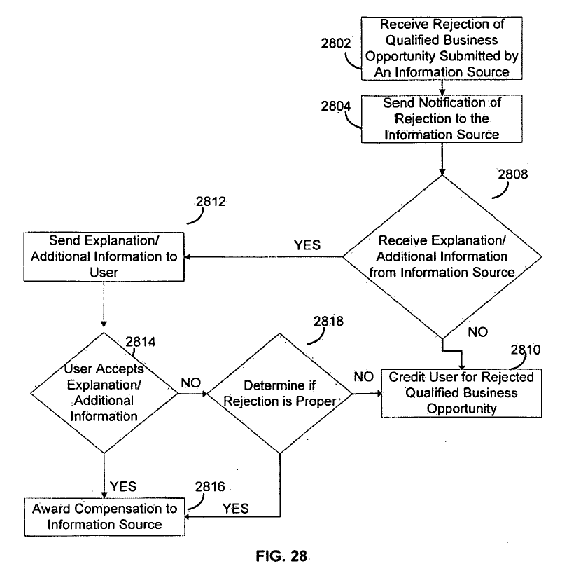

FIG. 28 illustrates a process flow of how a rejection is handled by some embodiments of the online information marketplace 104. Once the online information marketplace 104 receives a rejection of a qualified business opportunity from a user 106 (2802), the online information marketplace 104 may send a notification of the rejection to; the information source 102 that submitted the rejected qualified business opportunity. The notification may be any way of transmitting information, including but not limited to an e-mail, text message, update on an RSS feed, or message left on a web portal. The information source 102 may then submit an explanation to the online information marketplace 104 as to why the rejection is improper (2808). The information source 102 may also submit addition information to address the rejection, such as updated contact information, omitted information, or additional contacts.

For some embodiments, if the online information marketplace 104 does not receive any explanation or additional information (2808), the online information marketplace 104 may refund some or all of a fee charged for the qualified business opportunity (2810). For some embodiments, the refund may be received as a credit toward the purchase of other information from the online information marketplace 104. The amount of time that the online information marketplace 104 waits for a response from an information source 102 may vary based on polices of the online information marketplace 104. For some embodiments, the online information marketplace 104 may credit a user 106 for a rejected qualified business opportunity if there is no response from an information source 102 within one week.

Having received a response from the information source 102, the online information marketplace 104 sends the explanation and/or additional information to the user 106 (2812). The online information marketplace 104 may send the explanation or additional information using any form of communication, such as those discussed herein. The user 106 now has the opportunity to review the explanation and/or additional information provided by the information source 102. A user 106 may notify the online information marketplace 104 whether the user 106 accepts the explanation and/or additional information (2814). For some embodiments, an online information marketplace 104 may consider that the user 106 accepted the new information after a period of time, has passed. Certain embodiments determine the user 106 accepted the new information after a week from the time the user received the explanation and/or additional information.

If the user 106 accepts the information, the online information marketplace 104 awards the compensation to the information source 102. But, if the user 106 does not accept the explanation and additional information, the online information marketplace 104 credits the user 106 some or all fees paid for the rejected qualified business opportunity (2810). For some embodiments, after the user 106 rejects the explanation and the additional information, the online information marketplace 104 may determine if the rejection is proper based on the explanation and/or additional information provided by the information source 102 (2818). If the online information marketplace 104 determines the rejection to be valid, the user 106 is credited for some or all fees paid (2810). But, if the online information marketplace 104 determines the rejection is improper the information source 102 is awarded the compensation (2816).

For some embodiments, the online information market 104 may determine that the rejection is not proper if the qualified business opportunity meets all the criteria set out in the information request. Moreover, the online information market 104 may also determine that the rejection is not proper if the qualified business opportunity satisfies all the criteria in the information request after the explanation and/or additional information remedies any deficiencies in the originally submitted qualified business opportunity. However, if the timing of the submitted explanation and/or additional information caused the user 106 to miss out on the qualified business opportunity, the online information marketplace 104 may determine that the rejection is proper and credit the user 106.

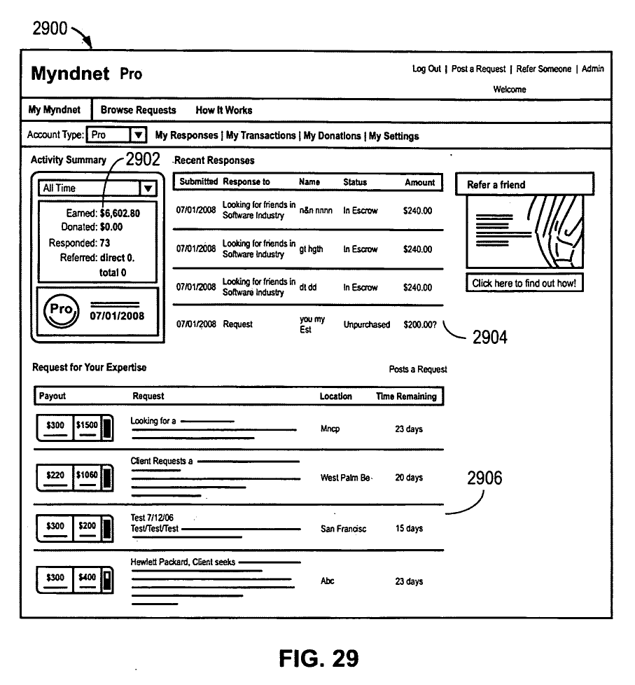

FIG. 29 illustrates an example of an information source web portal 2900 according to some embodiments of the online information marketplace 104. The web portal provides an information source 102 easy access to information. For example, the web portal illustrated in FIG. 29 provides an activity summary 2902, a recent responses list 2904, and request lists 2906. An activity summary 2902 may list the amount of compensation earned, amount of received compensation that has been donated, the number of responses submitted; referral information, or other items relating to the online information marketplace 104.

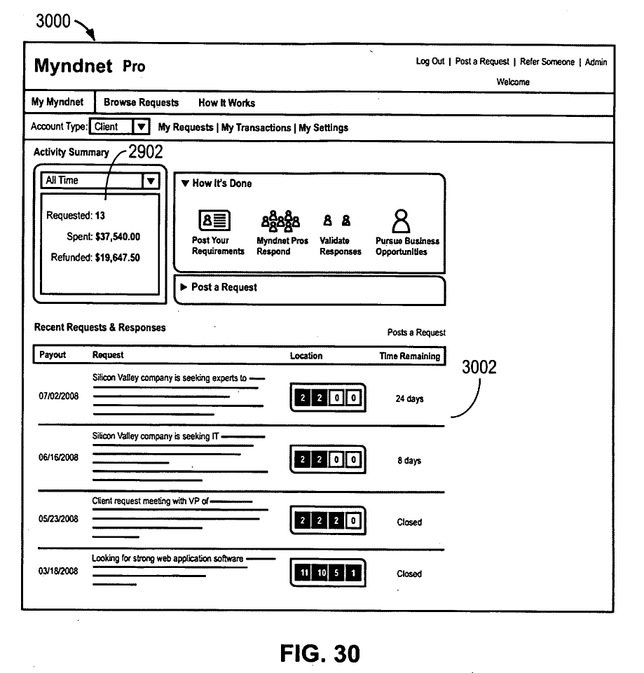

FIG. 30 illustrates another web portal for some embodiments of the online information marketplace 104. Specifically, FIG. 30 illustrates an example of a buyer web portal 3000. The FIG. 30 web portal includes an activity summary 2902 and a recent requests and responses list 3002. Similar to the activity summary 2902 discussed above, the activity summary may include a summary of activities a buyer performed on the online information marketplace 104. For example, an activity summary may include the number of requests a user 106 submitted, the amount of money spent on information requests, the amount of money refunded, and any other information that might be useful to a buyer of information.

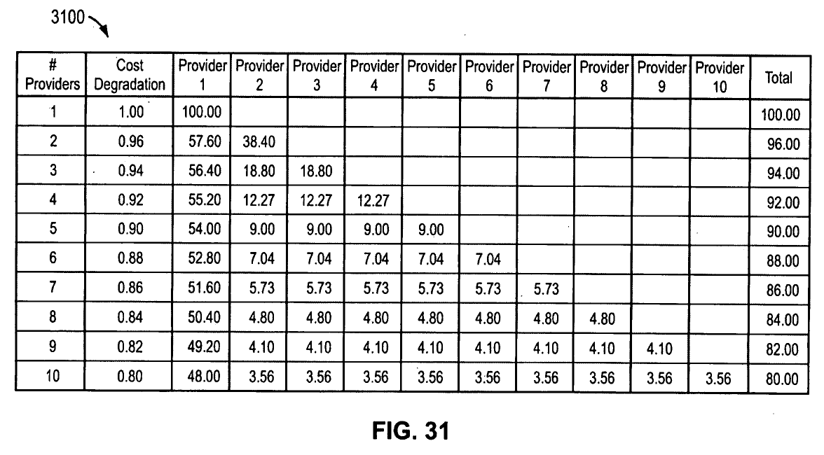

Attention is now directed to FIG. 31, which illustrates an exemplary table of amounts of compensation to one or more: information providers in accordance with some embodiments. The table 3100 illustrates the amounts of compensation given to one or more information sources 102 (labeled as “provider” or “providers” in the table) that provided an item of information (e.g., a contact), and that is awarded each time the item of information is purchased. The amounts are determined in accordance with a compensation formula that is based on the number of information sources 102 that provided the same item of information, which information source 102 provided the item of information first, a user's rating, and/or other criteria.

As described above, whenever an item of information is purchased, the one or more information sources 102 that provided that item of information are given compensation. For some embodiments, there is one total amount of compensation for an item of information, and that total amount is divided amongst the information sources 102 that provided the item of information. When there is only one information source 102 that has provided the item of information, he gets the full share of the total compensation. As the number of information sources 102 who provided the item of information increases, the source that provided the item of information first gets less than the full share of the total compensation. However, as he is the first to provide the item of information, he gets the largest share.

The remainder of the total compensation is distributed amongst the other information sources 102 that provided the same item of information. For some embodiments, the remainder is divided equally amongst the other information sources 102. In some other embodiments, the remainder is divided amongst the other information sources 102 such that the order in which me information is provided matters; the second information source 102 to provide the information gets a larger share of the remainder than the third source, the third source gets a larger share than the fourth source, and so on.

As an example of the distribution of the compensation amongst information sources 102, say that one or more information sources 102 provided the information that a contact named “John Doe” is a golfer, and that total, compensation for this item of information (that John Doe is a golfer) is $1 per purchase. If the one, or more information sources 102 include only one user 106, that one user 106 gets $1 for each purchase. If two users 106 had provided this item of information, the user 106 who first entered the item of information into the system gets $0.60 and the other user 106 gets $0.40. If three users 106 had provided this item of information, the user 106 that first entered the item of information into the system gets $0.56 and $0.44 is divided equally amongst the other two users 106.

For some embodiments, the total amount of compensation for an item of information may degrade as more and more information sources 102 provide the same item of information. As shown in the table 3100, the total amount of compensation (rightmost column) decreases as the number of information sources 102 increases. In some other embodiments, there is no degradation; the total amount of compensation is the same regardless of the number of information sources 102 that provided the item of information.

More generally, the amount of compensation for a specified information source 102 for a specific transaction; may be expressed as an algorithm or a mathematical formula. For some embodiments, the formula is

C(t,p)=(1−D(N(t)))·P(O(t,p),N(t))·V(t), where:
C(t, p) is the amount of compensation C for a specified information source p for a specified transaction t (e.g., a purchase of an item of information);
D(N(t)) is the degradation factor D, which is based on the number of information sources 102 N(t) who provided the item of information involved in the specified transaction;
P(O(t, p), N(t)) is the order preference factor P, which is based on N(t) and the order O(t, p) in which the information source p provided the item of information involved in the transaction t; and
V(t) is the total value or compensation amount for the transaction t. V(t) may be based on how focused or narrow was the search that yielded the item of information.

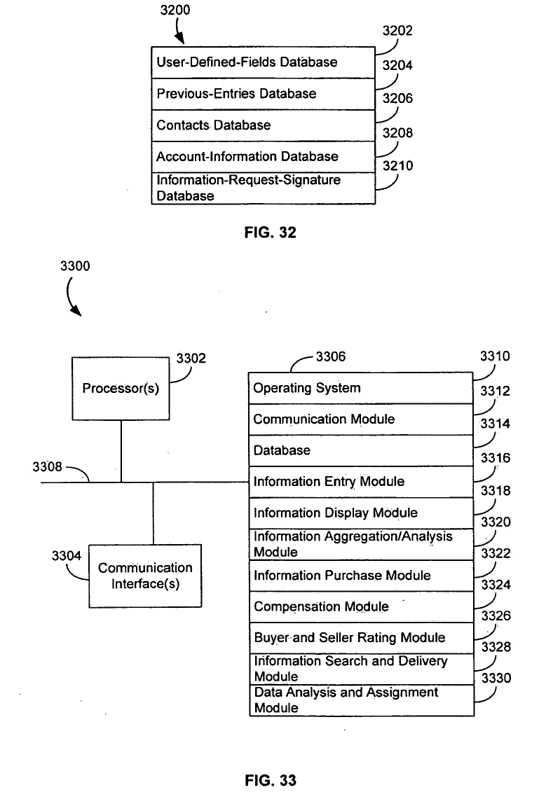

FIG. 32 illustrates a database structure 3200 used to create database 212 according to some embodiments of the online information marketplace 104. Thus, database 212 may be made up of a plurality of databases dedicated to storing a particular type of information. The database structure 3200 may include a user-defined fields database 3202 for storing user-defined fields created by a user 106. Moreover, the database structure 3200 includes a previous-entries database 3204 for storing entries previously submitted by a user 106. A contacts database 3206 may also be included in database structure 3200 for storing all the contacts acquired by the online information marketplace 104. Furthermore, the database structure 3200 may includes an account-information database 3208 for storing information on a user 106 including login, registration information, seller ratings; buyer ratings, information signature, and any other information related to a user 106. For some embodiments, this information may be broken out into separate databases. The database structure 3200 may also include an information-request-signature database 3210. However, a database structure 3200 for other embodiments of an online information marketplace may segment database 212 into different categories of databases than those described above. Thus, embodiments of the online information marketplace 104 are not limited to the categories described above.

FIG. 33 is a block diagram illustrating an information system 3300 of an online information marketplace 104 in accordance with some embodiments. The information system 3300 typically includes one or more processing units (CPU's) 3302, one or more network or other communications interfaces 3304, memory 3306, and one or more communication buses 3308 for interconnecting these components. The information system 3300 optionally may include a user interface (not shown) comprising a display device and a keyboard. The memory 3306 includes high-speed random access memory, such as DRAM, SRAM, DDR RAM or other random access solid state memory devices; and may include nonvolatile memory, such as one or more magnetic disk storage devices, optical disk storage devices, flash memory devices, or Other non-volatile solid state storage devices. Memory 3306 may optionally include one or more storage devices remotely located from the CPU(s) 3302. Moreover, memory 3306, or alternatively one or more storage devices (e.g., one or more nonvolatile storage devices) within memory 3306, includes a computer readable storage medium. For some embodiments; the memory 3306 stores the following programs, modules and data structures, or a subset thereof:
an operating system 3310 that includes procedures for handling various basic system services and for performing hardware dependent tasks;
a network communication module 3312 that is used for connecting the information system 3300 to other computers via the one or more communication network interfaces 3304 (wired or wireless), such as the Internet, other wide area networks, local area networks, metropolitan area networks, wireless networks, and so on;
a database 3314 for storing information, such as contact information and user account information;
an information entry module 3316 for receiving information entered by users 106 and storing the received information into the database 3314;
an information display module 3318 for displaying contact information to users 106 in accordance with/the provider or purchaser statuses of users 106;
an information aggregation and analysis module 3320 for aggregating and analyzing contact information in the database 3314;
an information purchase module 3322 for processing user requests to purchase contact information;
a compensation module 3324 for processing and forwarding compensation to information sources 102;
a buyer and seller rating module 3326 for determining a rating for a buyer and a seller of information;
an information search and delivery module 3328 for searching information and delivery information to a user 106; and
a data analysis and assignment module 3330 for analyzing data and assigning data to a user 106 likely to need or have information related to the data analyzed.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. For some embodiments, memory 3306 may store a subset of the modules and data structures identified above. Furthermore, memory 3306 may store additional modules and data structures not described above.

Although FIG. 33 shows an “information system,” FIG. 33 is intended more as functional description of the various features that may be present in a set of servers than as a structural schematic of the embodiments described herein. In practice, and as recognized by those of ordinary skill in the art, items shown separately could be combined and some items could be separated. For example, some items shown separately in FIG. 33 could be implemented on single servers and single items could be implemented by one or more servers. The actual number of servers used to implement an information system and how features are allocated among them will vary from one implementation to another, and may depend in part on the amount of data traffic that the system must handle during peak usage periods as well as during average usage periods.

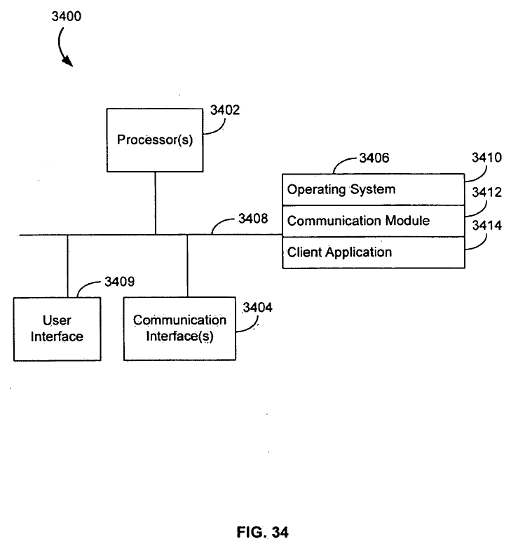

FIG. 34 is a block diagram of a client 3400. The client 3400 generally includes one or more processing units (CPU's) 3402, one or more network or other communications interfaces 3404; memory 3406, and one or more communication buses 3408 for interconnecting these components. The client 3400 also includes a user interface 3409, for instance a display and an input device. Memory 3406 may include high speed random access memory and may also include non-volatile memory, such as one or more magnetic disk storage devices. Memory 3406 may include mass storage that is remotely located from the central processing unit(s) 3402. Moreover, memory 3406, or alternatively one or more storage devices (e.g., one or more nonvolatile storage devices) within memory 3406, includes a computer readable storage medium. For some embodiments, the memory 3406 stores the following programs, modules and data structures, or a subset thereof:
an operating system 3410 that includes procedures for handling various basic system services and for performing hardware dependent tasks;
a network communication module 3412 that is used for connecting the information system 3400 to other computers via the one or more communication network interfaces 3404 (wired or wireless), such as the Internet, other wide area networks, local area networks, metropolitan area, networks, wireless networks, and so on; and
a client application 3414, such as a web browser, for accessing the online information marketplace 104.

The foregoing description, for purpose of explanation, has, been described with reference to specific embodiments. However, the illustrative discussions above are not intended to be exhaustive; or to limit the invention to the precise forms, disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for obtaining information comprising:
receiving an information request for a qualified business opportunity from a user;
providing said information request to an information source;
receiving said qualified business opportunity from said information source;
sending said qualified business opportunity to said user; and
awarding compensation to said information source.

2. The computer-implemented method of claim 1, wherein providing said criteria to said information source includes posting said information request on a web site.

3. The computer-implemented method of claim 1, wherein said information source registers to receive information requests for said qualified business opportunity.

4. The computer-implemented method of claim 1, wherein providing said information request to an information source is through a Really Simple Syndication (RSS) feed.

5. The computer-implemented method of claim 1, wherein providing said: information request to an information source includes matching said information request to said information source by analyzing a member profile of said information source and determining that said member profile is relevant to said information request.

6. The computer-implemented method of claim 5, wherein determining that said member profile is relevant to said information request includes analyzing a contact list for said information source.

7. The computer-implemented method of claim 5, wherein determining that said member profile is relevant to said information source includes analyzing any previously submitted qualified business opportunity received by said information source.

8. The computer-implemented method of claim 1, wherein awarding compensation to said information source is based on sales success from said qualified business opportunity.

9. A computer-implemented method for obtaining information comprising:
at a client:
receiving an information request for a qualified business opportunity from an online information marketplace;
submitting a qualified business opportunity to an online information marketplace in response to said information request; and
receiving a compensation award for said qualified business opportunity.

10. The computer-implemented method of claim 9 further comprising registering with said online information marketplace to indicate areas of expertise.

11. The computer-implemented method of claim 10 further comprising requesting from a prospect a confirmation of intent to engage in said qualified business opportunity.

12. The computer-implemented method of claim 11, wherein requesting from said prospect said confirmation of intent to engage in said qualified business opportunity is a request for an e-mail confirming intent to engage in said qualified business opportunity.

13. The computer-implemented method of claim 11 further comprising receiving from said prospect said confirmation of intent to engage in said qualified business opportunity.

14. A system to implement an online information marketplace comprising:
one or more processors;
memory; and
a program stored in said memory for execution by said one or more processors, the program including:
instructions for receiving an information request for a qualified business opportunity from an user,
instructions for providing said information request to an information source;
instructions for receiving said qualified business opportunity from said information source;
instructions for/sending said qualified business opportunity to said user; and
instructions for awarding compensation to said information source.

15. The system to implement an online information marketplace of claim 14, wherein instructions for providing said information request to an information source includes matching said information request to said information source by analyzing a member profile of said information source and determining that said member profile is relevant to said information request.

16. The system to implement an online information marketplace of claim 15, wherein determining that said member profile is relevant to said information request includes analyzing a contact list for said information source.

17. The system to implement an online information marketplace of claim 15, wherein determining that said member profile is relevant to said information source further includes analyzing any previously submitted qualified business opportunity received by said information source.

18. The system to implement an online information marketplace of claim 14, wherein instructions for awarding compensation to said, information source is based on sales success from said qualified business opportunity.

19. The system to implement an online information marketplace of claim 14 further comprising instructions for requesting from a prospect a confirmation of intent, to engage in said qualified business opportunity.

20. The system to implement an online information marketplace of claim 19 further comprising instructions, for receiving from said prospect said confirmation of intent to engage in said qualified business opportunity.
